(19) United States
(12) Patent Application Publication
(10) Pub. No.: US 2026/0197235 A1
(43) Pub. Date: Jul. 9, 2026

(54) Methods And Apparatus For Sensing Node Maintenance In Mobile Communications

(71) Applicant: MediaTek Singapore Pte. Ltd., Singapore (SG)

(72) Inventors: Wenze Qu, Beijing (CN); Jianwei Zhang, Beijing (CN); Chiao-Yao Chuang, Hsinchu City (TW); Min Lei, Beijing (CN); Haoran Li, Beijing (CN); Xuanbo Shao, Beijing (CN); Tao Chen, Beijing (CN)

(73) Assignee: MediaTek Singapore Pte. Ltd., Singapore (SG)

(21) Appl. No.: 19/439,269

(22) Filed: Jan. 2, 2026

(30) Foreign Application Priority Data
Jan. 3, 2025 (WO) PCT/CN2025/070434
Dec. 25, 2025 (CN) 202511982456.7

(51) Int. Cl. H04L 41/082; H04W 24/08

(52) U.S. Cl. CPC H04L 41/082; H04W 24/08

(57) ABSTRACT

Various solutions for sensing node maintenance with respect to an apparatus in mobile communications are described. The apparatus may establish a first sensing node set from a second sensing node set. The apparatus may perform at least one sensing operation with the first sensing node set. The apparatus may update the first sensing node set. The apparatus may configure the first sensing node set based on result of updating.

### CROSS REFERENCE TO RELATED PATENT APPLICATION(S)

The present disclosure is part of a non-provisional application claiming the priority benefit of PCT Application No. PCT/CN2025/070434, filed on 3 Jan. 2025, and CN application No. 202511982456.7, filed on 25 Dec. 2025, the content of which herein being incorporated by reference in their entirety.

### TECHNICAL FIELD

The present disclosure is generally related to mobile communications and, more particularly, to sensing node maintenance with respect to apparatus in mobile communications.

### BACKGROUND

Unless otherwise indicated herein, approaches described in this section are not prior art to the claims listed below and are not admitted as prior art by inclusion in this section.

In New Radio (NR) mobile communications, Integrated Sensing and Communication (ISAC) systems have been developed. In particular, ISAC systems may enable simultaneous environmental sensing and wireless communication by reusing shared waveform resources (e.g., Orthogonal Frequency-Division Multiplexing (OFDM) signals).

To ensure the performance of the sensing service, sensing nodes may initially be determined based on the sensing service requirements. Furthermore, during sensing operation for the sensing service, the sensing nodes may need to be updated based on the capabilities of the sensing nodes, the positions of the sensing nodes and targets, and the channel conditions change. However, existing ISAC systems do not provide an appropriate protocol or procedure for properly managing sensing nodes to maintain continuity and performance of the sensing service.

Accordingly, how to properly manage sensing nodes to maintain continuity and performance of the sensing service in ISAC systems has become an important issue in the newly developed wireless communication network. Therefore, there is a need to properly manage sensing nodes to maintain continuity and performance of the sensing service in ISAC systems.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to sensing node maintenance with respect to apparatus in mobile communications.

In one aspect, a method may involve an apparatus establishing a first sensing node set from a second sensing node set. The method may further involve the apparatus performing at least one sensing operation with the first sensing node set. The method may further involve the apparatus updating the first sensing node set. The method may further involve the apparatus configuring the first sensing node set based on result of updating.

In one aspect, an apparatus may comprise a transceiver which, during operation, wirelessly communicates with a wireless network. The apparatus may also comprise a processor communicatively coupled to the transceiver. The processor, during operation, may perform operations comprising establishing a first sensing node set from a second sensing node set. The processor may further perform operations comprising performing at least one sensing operation with the first sensing node set. The processor may further perform operations comprising updating the first sensing node set. The processor may further perform operations comprising configuring the first sensing node set based on result of updating.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIGS. 7A to 7I are diagrams depicting example scenarios under schemes in accordance with implementations of the present disclosure.

FIGS. 8A to 8M are diagrams depicting example scenarios under schemes in accordance with implementations of the present disclosure.

FIG. 9 is a diagram depicting an example scenario under schemes in accordance with implementations of the present disclosure.

FIG. 10 is a block diagram of an example communication system in accordance with an implementation of the present disclosure.

FIG. 11 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to sensing node maintenance with respect to apparatus in mobile communications. According to the present disclosure, a number of possible solutions may be implemented separately or jointly. That is, although these possible solutions may be described below separately, two or more of these possible solutions may be implemented in one combination or another.

First, it should be noted that, in an Integrated Sensing And Communication (ISAC) system, there may be one or more sensing nodes. The sensing nodes may include transmitter (TX) and receiver (RX). In some scenarios, the TX and RX may be either co-located or spatially separated. When the TX and RX are co-located, for example, within a common sensing node, the system may be referred to as a monostatic sensing system. When the TX and RX are disposed at different locations, for example, within different sensing nodes, the system may be referred to as a bistatic sensing system. It should be noted that the following disclosed techniques may be applied to either a monostatic sensing system or a bistatic sensing system.

Regarding the present disclosure, a network node (e.g., a Base Station (BS), a Core Network (CN) or a User Equipment (UE) having sensing function) may establish a first sensing node set from a second sensing node set. In other words, the network node may select sensing node(s) from the second sensing node set to form the first sensing node set. The network node may perform at least one sensing operation with sensing node(s) of the first sensing node set. After performing the at least one sensing operation, the network node may update the first sensing node set and configure the first sensing node set based on the result of updating.

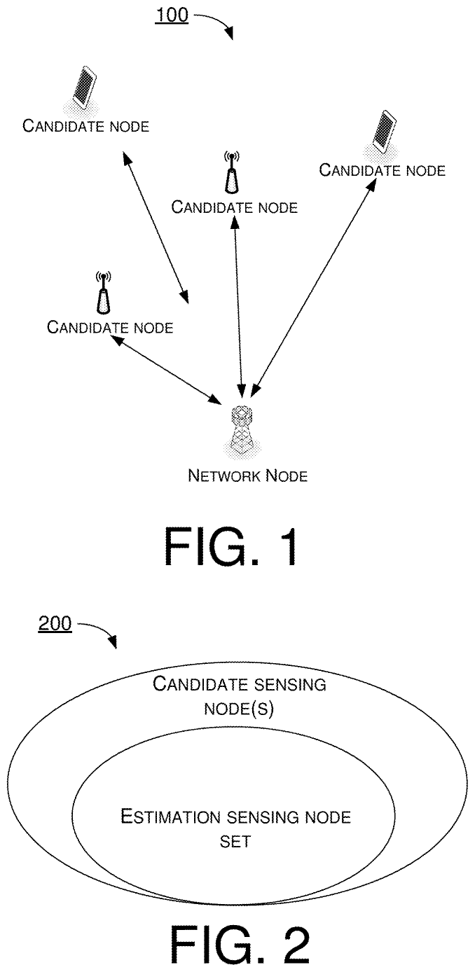

FIG. 1 illustrates an example scenario 100 under schemes in accordance with implementations of the present disclosure. In some embodiments, an ISAC system may include a network node (e.g., a BS, a CN or a UE having sensing function) and at least one candidate sensing node (e.g., BS and/or UE). The network node may establish a first sensing node set from the at least one candidate sensing node. More specifically, the network node may select one or more sensing nodes from the at least one candidate sensing node, the selected sensing nodes being used to perform the sensing operation, to thereby form the first sensing node set (i.e., an estimation sensing node set).

In some implementations, each element of the first sensing node set may correspond to: (1) single sensing node, or (2) one sensing node of a sensing node-pair. In particular, to perform monostatic sensing operation, bistatic sensing operation and/or multi-static sensing operation, the single sensing node may be a BS or a UE, and the sensing node-pair may be a UE-UE pair, a BS-UE pair or a BS-BS pair. In other words, the first sensing node set may include a single sensing node (or sensing node pair for bistatic sensing) and/or multiple sensing nodes (or sensing node pairs) for cooperative sensing. In some cases, for a multi-stage type sensing task, multiple sensing node sets may be used and maintained.

In some implementations, the network node may perform the at least one sensing operation with selected sensing node(s) in the first sensing node set. After performing the at least one sensing operation, the network node may update the first sensing node set and configure the first sensing node set based on the result of updating.

FIG. 2 illustrates an example scenario 200 under schemes in accordance with implementations of the present disclosure. In some implementations, the second sensing node set may include the at least one candidate sensing node. The first sensing node set may be an estimation sensing node set. In these implementations, the estimation sensing node set and the second sensing node set may be used for parameters estimation of known target(s) (e.g., respiration detection), and the estimation sensing node set may be managed.

In some implementations, the network node may establish a third sensing node set from the first sensing node set. More specifically, the network node may select one or more sensing nodes in the first sensing node, the selected sensing nodes being used to perform at least one other sensing operation, to thereby form the third sensing node set.

In some implementations, the network node may perform the at least one other sensing operation with selected sensing node(s) in the third sensing node set. After performing the at least one other sensing operation, the network node may update the third sensing node set and configure the third sensing node set based on the result of updating.

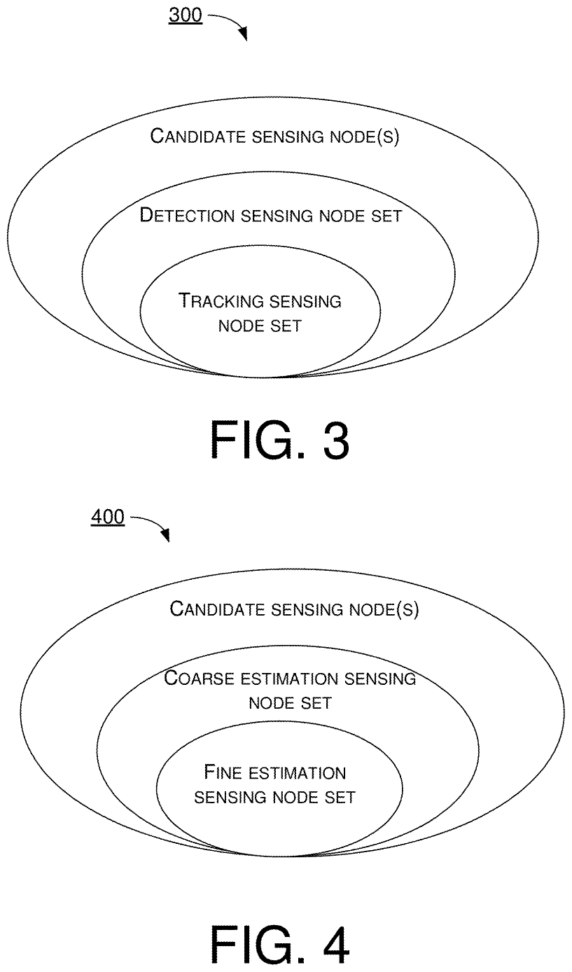

FIG. 3 illustrates an example scenario 300 under schemes in accordance with implementations of the present disclosure. In some implementations, the second sensing node set may include the at least one candidate sensing node. The first sensing node set may be a detection sensing node set. The third sensing node set may be a tracking sensing node set. In these implementations, the detection sensing node set, the tracking sensing node set and the second sensing node set may be used for target detection and tracking (e.g., Unmanned Aerial Vehicle (UAV) detection and tracking), and the detection sensing node set and the tracking sensing node set may be managed.

FIG. 4 illustrates an example scenario 400 under schemes in accordance with implementations of the present disclosure. In some implementations, the second sensing node set may include the at least one candidate sensing node. The first sensing node set may be a coarse estimation sensing node set. The third sensing node set may be a fine estimation sensing node set. In these implementations, the coarse estimation sensing node set, the fine estimation sensing node set and the second sensing node set may be used for target detection and parameter estimation (e.g., target detection and identification), and the coarse estimation sensing node set and the fine estimation sensing node set may be managed.

In some implementations, to each of the previous scenarios (e.g., scenarios in FIGS. 2 to 4), a procedure may be generalized for: (1) sensing node set maintenance (e.g., establishment and updating), (2) sensing operations performed by the sensing nodes, and (3) operations related to switching the sensing nodes, and for clarifying the relationships among these operations.

Furthermore, the procedure may be applied for managing the relation between: (1) the estimation sensing node set and the at least one candidate sensing node, (2) the detection sensing node set and the tracking sensing node set, or (3) the coarse estimation sensing node set and the fine estimation sensing node set. For a multi-stage type task, each sensing node set may maintain a separate procedure, and interrelationships may exist between the procedures of different sets at certain steps.

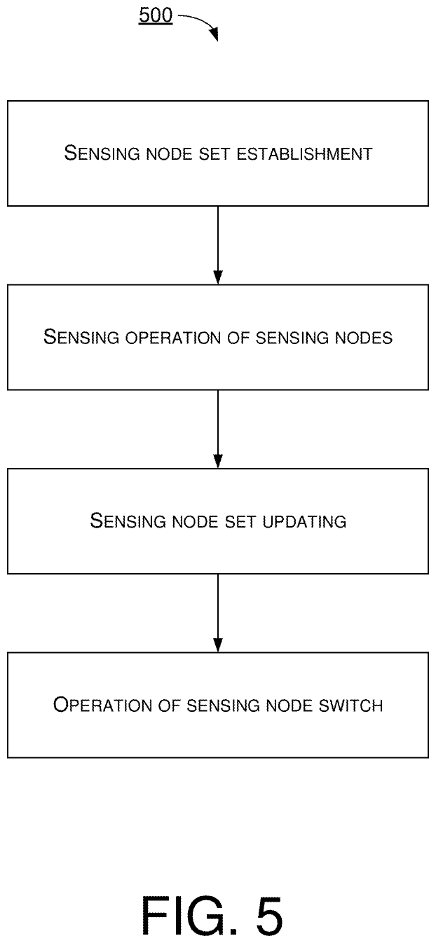

FIG. 5 illustrates an example scenario 500 under schemes in accordance with implementations of the present disclosure. In some implementations, the procedure may include: (1) sensing node set establishment, (2) sensing operation of sensing nodes, (3) sensing node set updating, and (4) operation of sensing node switch.

In some cases, the procedure may include: (1) sensing node set establishment which may include establishing the first sensing node set (e.g., estimation sensing node set, detection sensing node set or coarse estimation sensing node set) from the second node set (e.g., the candidate sensing node(s)), (2) sensing operation of sensing nodes which may include performing the at least one sensing operation with the first sensing node set, (3) sensing node set updating which may include updating the first sensing node set, and (4) operation of sensing node switch.

In some cases, the procedure may include: (1) sensing node set establishment which may include establishing the third sensing node set (e.g., tracking sensing node set or fine estimation sensing node set) from the first sensing node set (e.g., detection sensing node set or the coarse estimation sensing node set), (2) sensing operation of sensing nodes which may include performing the at least one sensing operation with the third sensing node set, (3) sensing node set updating which may include updating the third sensing node set, and (4) operation of sensing node switch.

In some implementations, with respect to the procedure, the sensing nodes and the network node having sensing function may interact with each other. In particular, the network node may be a sensing task manager. The network node may: (1) establish and update sensing node set(s), (2) configure sensing task and task requirement (e.g., Quality of Service (QoS)) for sensing node(s), (3) control operation of sensing nodes switch, (4) suggest or determine sensing resource (e.g., when the network node is CN, the network node may suggest sensing resource; when the network node is BS or UE, the network node may determine sensing resource), and (5) collect and integrate sensing data of sensing node(s) and calculate sensing results.

Furthermore, the candidate sensing node(s) may be all nodes with sensing capability in a sensing area. The candidate sensing node(s) may report detailed sensing capability to the network node. The sensing node(s), selected from the candidate sensing nodes, may: (1) transmit and receive sensing signal(s), (2) process sensing signal(s) to generate sensing data, and (3) report the sensing data to the network node when necessary.

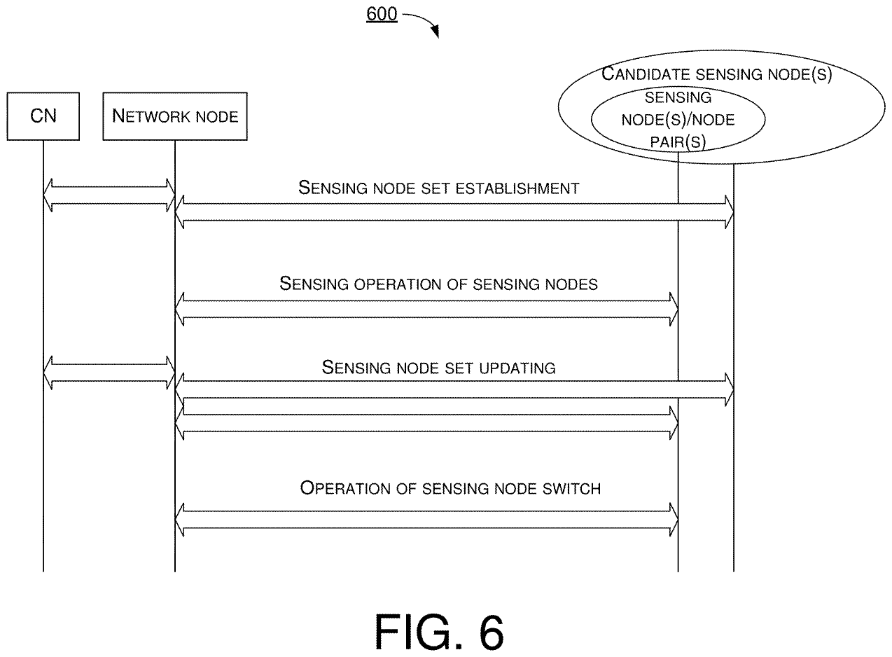

FIG. 6 illustrates an example scenario 600 under schemes in accordance with implementations of the present disclosure. In some implementations, the procedure between the CN, the network node and the sensing node(s)/sensing node pair(s) may include four main steps: (1) sensing node set establishment, (2) sensing operation of sensing nodes, (3) sensing node set updating, and (4) operation of sensing node switch.

It should be noted that the network node and the CN are shown as separate entities in FIG. 6. This illustration is not intended to limit the present disclosure. A person skilled in the art should readily understand that the network node may be implemented as part of the CN, such that the network node and the CN may be the same entity.

In some implementations, a two-stage type task may be used as an example to introduce each step of the procedure. Procedures for the first sensing node set and the third sensing node set may be separate.

In some implementations, with respect to the procedure for the first sensing node set, the step of sensing node set establishment may include: (1) obtaining candidate node information from the at least one candidate sensing node, and (2) selecting at least one sensing node from the at least one candidate sensing node to establish the first sensing node set based on the candidate node information.

More specifically, with respect to obtaining candidate node information, the network node may collect candidate node information. The network node may trigger the at least one candidate sensing node to report sensing related information. The sensing related information may be associated with dimensions of sensing capability information, position information and signal quality information.

In some cases, the sensing capability information may include: (1) supporting sensing or not, (2) supported sensing quantities, (3) corresponding sensing accuracy and resolution for each measurement quantity, (4) coverage of sensing range, (5) supported sensing mode, (6) whether the node may act as a sensing TX, a sensing RX, or both, (7) capability of sensing resource configuration, and/or (8) supporting multi-static sensing (BSs-UE, BS-UEs) or not.

In some cases, the position information may include (1) Global Positioning System (GPS) information, and/or (2) positioning (e.g., Downlink (DL) or Uplink (UL)) related information.

In some cases, the signal quality information may include DL or UL communication link quality between the network node (e.g., BS) and the sensing node (e.g., UE). The signal quality information may include Received Signal Strength Indicator (RSSI), Reference Signal Received Power (RSRP), Reference Signal Received Quality (RSRQ) and/or Signal-to-Noise Ratio (SNR) measured by the network node (e.g., BS) and the sensing node (e.g., UE).

In some cases, the network node (e.g., BS) may collect other information from CN (e.g., collect node position information from Location Management Function (LMF)).

Furthermore, with respect to selecting at least one sensing node from the at least one candidate sensing node, the network node may select at least one sensing node to form the first sensing node set based on sensing service requirements and collected candidate node information. In some cases, the selection criteria may primarily depend on whether the sensing capability and position of the node satisfy the sensing service requirements.

In some implementations, with respect to the procedure for the first sensing node set, the step of sensing operation of sensing nodes may include: (1) configuring the first sensing node set for a sensing signal processing procedure (i.e., sensing node configuration exchange, sensing signal transmission, sensing signal reception, and sensing signal processing), (2) receiving sensing data from the first sensing node set, and (3) determining a sensing result based on the sensing data.

More specifically, with respect to sensing node configuration exchange, the network node may trigger every sensing node (or sensing node-pair) in the first sensing node set to start sensing task. The network node may need to provide detailed information of sensing task, including task details (e.g., suggested sensing resource and requirements of sensing task).

Furthermore, with respect to sensing signal transmission, reception and processing, the sensing node (or sensing node-pair) may determine details of sensing resource configuration based on information from the network node. In some cases, the sensing resource configuration may include a sensing signal time, frequency and spatial-domain pattern, a time-domain duration and period, and a transmit power. In addition, the sensing node (or sensing node-pair) may start sensing signal transmission, reception and processing. In some cases, these operations may be periodic, semi-persistent or aperiodic, depending on sensing task requirement. In some cases, the sensing signal processing may include radar sensing algorithm (e.g., 2D-Fast Fourier Transform (2D-FFT), Multiple Signal Classification (MUSIC), or Iterative Adaptive Approach (IAA)) and non-ideal factor elimination process (e.g., synchronization algorithm).

Furthermore, with respect to receiving the sensing data, each sensing node (or sensing node-pair) may report the sensing data to the network node. In some cases, for bistatic sensing, the RX sensing node may report sensing data. In some cases, the sensing data may include required sensing measurement quantities, and may further include corresponding quality information that may be used to assess the reliability of the sensing result.

Furthermore, with respect to determining the sensing result based on the sensing data, the network node may integrate all sensing nodes (or sensing node-pairs) reporting and calculate the final sensing result of a corresponding sensing service. In some cases, there may be one or more targets. The network node may employ a target clustering algorithm to associate the targets with the sensing data of each sensing node.

In some implementations, with respect to the procedure for the first sensing node set, the step of sensing node set updating may include: (1) obtaining updated node information from the at least one candidate sensing node and the first sensing node set, and (2) updating the first sensing node set based on the updated candidate node information.

More specifically, with respect to obtaining updated node information, the network node may collect updating information of all candidate sensing node(s). In some cases, obtaining the candidate node information may be performed in the same manner as in the step of sensing node set establishment. The candidate node information may be reported periodically by the candidate sensing node(s), or aperiodically in response to a trigger from the network node or from the candidate sensing nodes themselves (e.g., when a sensing capability has changed).

In some cases, the updated node information may include at least one of: (1) updated candidate sensing node information from the at least one candidate sensing node, and (2) sensing data and quality information from the first sensing node set. The network node may collect the sensing data and corresponding quality information from the sensing node(s) in the first sensing node set. Such information may indicate whether a target is detected and whether the quality of the sensing result is acceptable.

In some cases, when a serving cell BS and a UE form a sensing node-pair of the first sensing node set, and a handover of the UE occurs, the serving cell BS may inform the network node, and the network node may determine whether the sensing node-pair needs to be updated.

Furthermore, with respect to updating the first sensing node set, the network node may update the first sensing node set based on the collected information, which may include: (1) adding at least one element to the first sensing node set, and (2) removing at least one element from the first sensing node set. In other words, updating the first sensing node set may include: (1) selecting new sensing node(s) (or sensing node-pair(s)) from the candidate node(s) to be added to the first sensing node set, and (2) removing original sensing node(s) (or sensing node-pair(s)) from the first sensing node set.

In some cases, some sensing nodes may become closer to the target or may exhibit improved sensing capabilities. Such sensing nodes may be added to the first sensing node set. In some cases, some original sensing nodes may experience degraded sensing capabilities or poor sensing quality. These sensing nodes may be removed from the first sensing node set.

In some cases, when a serving cell BS and a UE form a sensing node-pair of the first sensing node set, and a handover of the UE occurs, the BS of the sensing node-pair may be updated from a previous serving cell BS to the new serving cell BS.

In some implementations, with respect to the procedure for the first sensing node set, the step of operation of sensing node switch may include: (1) configuring at least one element removed from the first sensing node set to stop performing corresponding sensing operation, and (2) configuring the first sensing node set to perform corresponding sensing operation.

More specifically, with respect to configuring at least one element removed from the first sensing node set to stop performing corresponding sensing operation, before the sensing node (or sensing node-pair) stopping sensing operation, the sensing node may need to report some information to the network node (e.g., sensing resource configuration, sensing data, etc.). The information may assist new node configuration(s) and sensing data calculation(s).

Furthermore, with respect to configuring the first sensing node set to perform corresponding sensing operation, the network node may trigger the sensing node(s) in the updated first sensing node set to start sensing, which may be performed in the same manner as in the step of sensing operation of sensing nodes.

In some cases, the new sensing node (or sensing node-pair) may start sensing operation(s). The operation(s) may be performed in the same manner as in the sensing operation step for the sensing nodes, with the difference being that information from the original sensing nodes, such as target information and sensing resource configuration information, may be used as reference for sensing configuration and for sensing data calculation.

In some cases, for the sensing nodes that were originally included in the first sensing node set prior to the update, the sensing configuration may be adjusted based on previous sensing results and corresponding quality information (e.g., sensing signal resources, time-domain periods, etc.).

In some implementations, with respect to the procedure for the third sensing node set, the step the step of sensing node set establishment may include: (1) obtaining sensing node information from the first sensing node set, and (2) selecting at least one sensing node from the first sensing node set to establish the third sensing node set based on the sensing node information.

More specifically, with respect to obtaining the sensing node information, the network node may collect the sensing node information. The network node may trigger the sensing node(s) (or sensing node-pair(s)) of the first sensing node set to report sensing related information. In some cases, the sensing node information of the first sensing node set may be reported periodically by the sensing nodes, or may be reported aperiodically in response to a trigger from the network node or from the sensing nodes themselves (e.g., when a sensing capability changes). The sensing information may include whether target is detected or not, target's parameters, sensing result quality, etc.

In some cases, the network node (e.g., BS) may collect other information from CN (e.g., collect node position information from LMF).

Furthermore, with respect to selecting at least one sensing node from the first sensing node set, the network node may select at least one sensing node to form the third sensing node set based on sensing service requirements and collected sensing node information of the first sensing node set. In some cases, the selection criteria may primarily depend on whether the sensing capability, position, and accuracy of the node satisfy the sensing service requirements. For example, the criteria may include: (1) whether the target can be detected, (2) whether the sensing quality is sufficient, (3) whether the distance to the target meets the required threshold, and (4) whether the node is capable of supporting high-accuracy sensing or tracking.

In some implementations, with respect to the procedure for the third sensing node set, since the sensing nodes in the third sensing node set may also belong to the first sensing node set, the third sensing node set may need to perform both the sensing operations of the first sensing node set and those of the third sensing node set. The two scenarios of sensing operations may be configured and performed together or separately. For simplicity, the sensing operations for the first sensing node set are not further described hereinafter.

In particular, with respect to the third sensing node set, the step of sensing operation of sensing nodes may include: (1) configuring the first sensing node set for a sensing signal processing procedure (i.e., sensing node configuration exchange, sensing signal transmission, sensing signal reception, and sensing signal processing), (2) receiving sensing data from the first sensing node set, and (3) determining a sensing result based on the sensing data.

More specifically, with respect to sensing node configuration exchange, the network node may trigger every sensing node (or sensing node-pair) in the third sensing node set to start new sensing task. The network node may need to provide detailed information of the sensing task (e.g., suggested sensing resource and requirements of the sensing task. Since the sensing nodes in the third sensing node set also belong to the first sensing node set, he sensing nodes in the third sensing node set may need to perform sensing operations of both the first sensing node set and the third sensing node set.

Furthermore, with respect to sensing signal transmission, reception and processing, the sensing node (or sensing node-pair) may determine details of sensing resource configuration based on information from the network node. In some cases, sensing resource configuration may include sensing signal time, frequency and spatial domain pattern, time domain duration and period. Sensing results and resource configuration of the sensing nodes in the first sensing node set may be used as reference in the resource configuration (e.g., detected target's position and beam index of configured resource for the sensing nodes in the first sensing node set may be used for beam configuration for nodes in the third sensing node set.)

In addition, the sensing node (or sensing node-pair) may start sensing signal transmission, reception and processing. In some cases, these operations may be periodic, semi-persistent or aperiodic, depending on sensing task requirement. In some cases, the sensing signal processing may include radar sensing algorithm (e.g., 2D-FFT, MUSIC, or IAA and non-ideal factor elimination process (e.g., synchronization algorithm)).

Furthermore, with respect to receiving the sensing data and to determining the sensing result based on the sensing data, these operations may be performed in the same manner as in the step of receiving the sensing data and determining the sensing result based on the sensing data for the first sensing node set.

In some implementations, with respect to the procedure for the third sensing node set, the step of sensing node set updating may include: (1) obtaining updated node information from the first sensing node set and the third sensing node set, and (2) updating the third sensing node set based on the updated sensing node information.

More specifically, with respect to obtaining updated node information, the network node may collect updating information of all sensing node(s) from the first sensing node set and the third sensing node set. In some cases, the network node may collect sensing data and corresponding quality information of the sensing node(s) in the third sensing node set. The sensing capability updated information may also be collected. In some cases, when some sensing node(s) (or sensing node-pair(s)) is removed from the first sensing node set, the sensing node(s) may be reported to the network and may not be selected into the third sensing node set. In some cases, the information associated with the first sensing node set and the third sensing node set may be reported periodically by the sensing nodes, or may be reported aperiodically in response to a trigger from the network node or from the sensing nodes themselves.

Furthermore, with respect to updating the first sensing node set, the network node may update the third sensing node set based on the collected information, which may include: (1) adding at least one element to the third sensing node set, and (2) removing at least one element from the third sensing node set. In other words, updating the first sensing node set may include: (1) selecting new sensing node(s) (or sensing node-pair(s)) from the first sensing node set to be added to the third sensing node set, and (2) removing original sensing node(s) (or sensing node-pair(s)) from the third sensing node set.

In some cases, some sensing nodes in the first sensing node set may become closer to the target or may exhibit improved sensing capabilities. Such sensing nodes may be added to the third sensing node set. In some cases, some original sensing nodes in the third sensing node set may experience degraded sensing capabilities or poor sensing quality. These sensing nodes may be removed from the third sensing node set.

In some implementations, with respect to the procedure for the third sensing node set, the step of operation of sensing node switch may include: (1) configuring at least one element removed from the third sensing node set to stop performing corresponding sensing operation, and (2) configuring the third sensing node set to perform corresponding sensing operation.

More specifically, with respect to configuring at least one element removed from the third sensing node set to stop performing corresponding sensing operation, the sensing node(s) removed from the third sensing node set may reconfigure sensing operations. In some cases, the removed sensing node(s) may need to stop sensing operation associated with the third sensing node set. In some cases, the removed sensing node(s) may still need to perform sensing operation associated with the first sensing node set (if the sensing node(s) removed from the third sensing node det are still in the first sensing node set.) In addition, before the sensing node (or sensing node-pair) stopping sensing operation, the sensing node may need to report some information to the network node (e.g., sensing resource configuration, sensing data, etc.). The information may assist new node configuration(s) and sensing data calculation(s).

Furthermore, with respect to configuring the first sensing node set to perform corresponding sensing operation associated with the third sensing node set, the network node may trigger the sensing node(s) in the updated third sensing node set to start sensing, which may be performed in the same manner as in the step of sensing operation of sensing nodes. In some cases, since the sensing node(s) (or sensing node-pairs) may also be in the first sensing node set, the sensing node(s) may also perform sensing operation associated with the first sensing node set simultaneously.

In some cases, the new sensing node (or sensing node-pair) may start sensing operation(s). The operation(s) may be performed in the same manner as in the sensing operation step for the sensing nodes, with the difference being that there may be some information (target information, sensing resource configuration information, etc.) from the original nodes in the third sensing node set which may be as reference for sensing configuration and sensing data calculation.

In some implementations, the sensing node(s) may include one or more BSs or BS-pairs. Sensing mode may be BS monostatic sensing or bistatic sensing including multi-static sensing (BS-BSs).

In some cases, for single-stage type scenario, the first sensing node set may be maintained. According to the sensing area and candidate BS sensing capability, the initial sensing BSs (or sensing BS-pairs) may be determined, which includes the establishment of the first sensing node set. The first sensing node set may be updated based on sensing results of sensing nodes in the first sensing node set and sensing capability changes of candidate BSs.

In some cases, for two-stage type scenario, the first sensing node set and the third sensing node set may be maintained. The maintenance of the first sensing node set may be the same as that of single-stage type scenario. When some sensing BSs (or sensing BS-pairs) in the first sensing node set detect the target(s), the network node may select some sensing BSs (or sensing node-pairs) to track the target(s) (may use different sensing resources than detection). These selected sensing BSs (or sensing BS-pairs) may be added into the third sensing node set which may be a subset of the first sensing node set.

In some cases, (1) since the target(s) may be moving, (2) the capabilities of the sensing BSs (or sensing BS-Pairs) may be also changing, and (3) sensing BSs (sensing BS-pairs) in the first sensing node set may find new targets, the third sensing node set may be constantly updated.

In some cases, with respect to relationship with communication handover, when the target is UE, a corresponding serving cell BS may be the sensing BS or one of sensing BSs. In these cases, when a communication handover occurs, the previous serving cell BS may inform the network node to update the sensing node set. The previous serving cell BS (i.e., the previous sensing BS) may also need to transfer its sensing configuration and sensing data/result to a new serving cell BS (i.e., the new sensing BS). The new serving cell BS may use this information as a reference for its sensing configuration and for sensing data/result calculation.

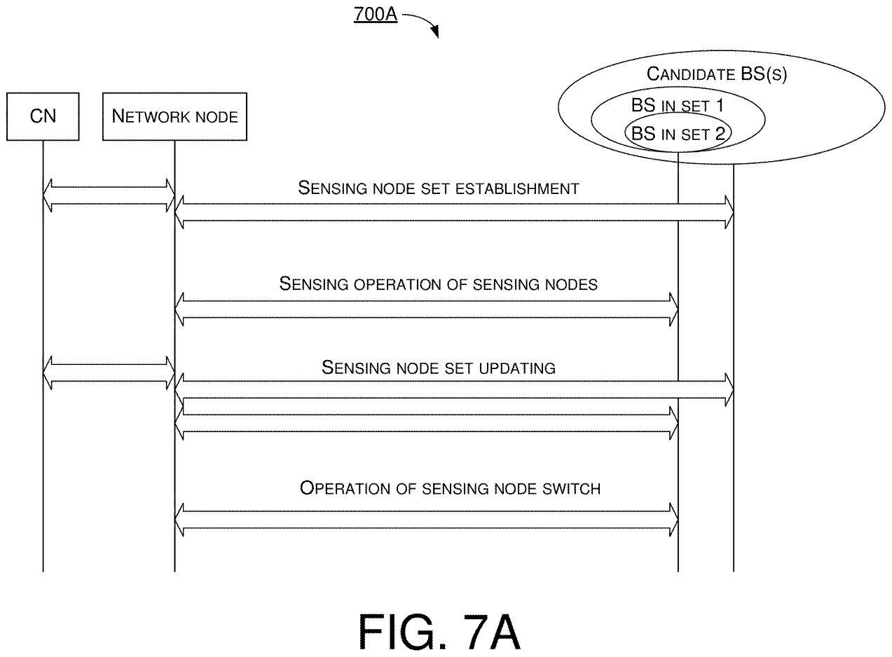

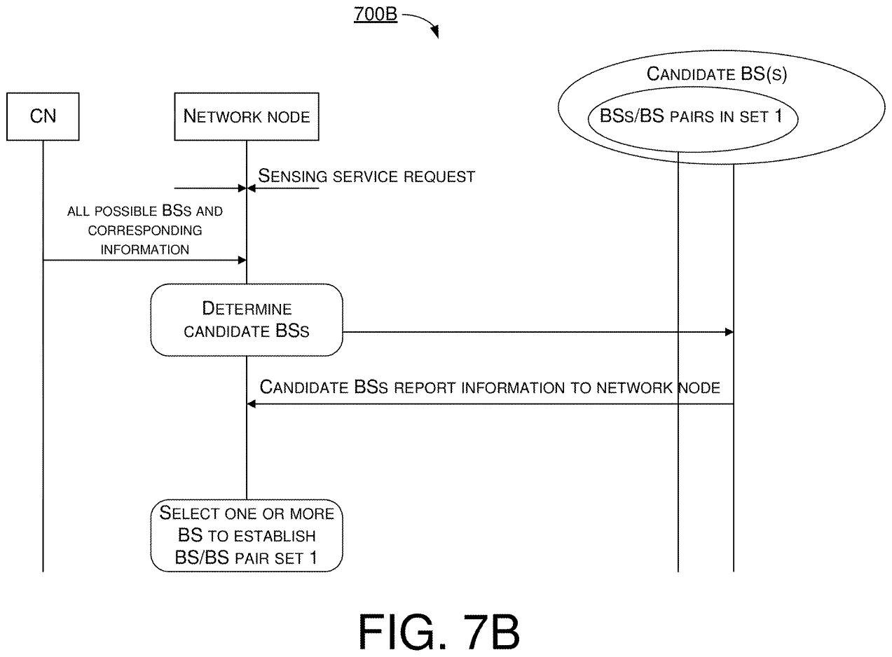

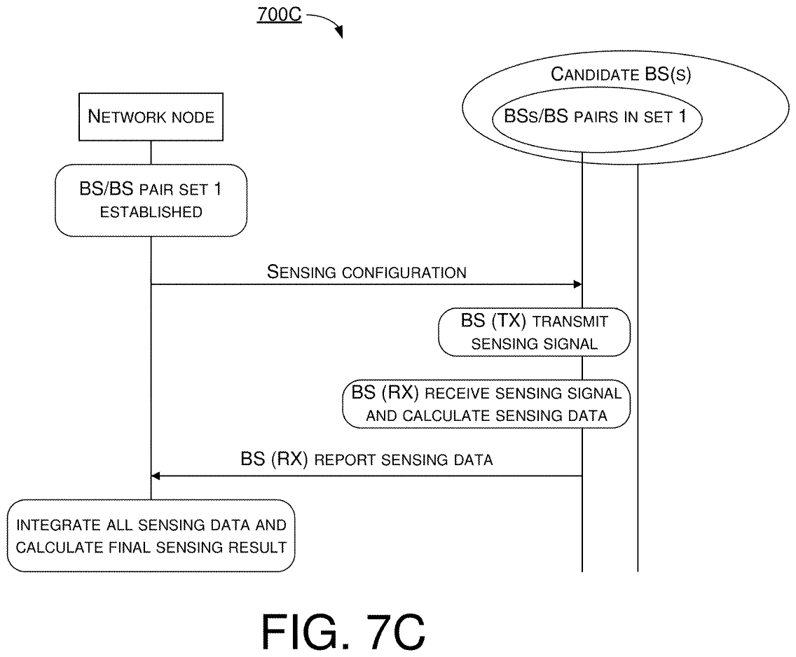

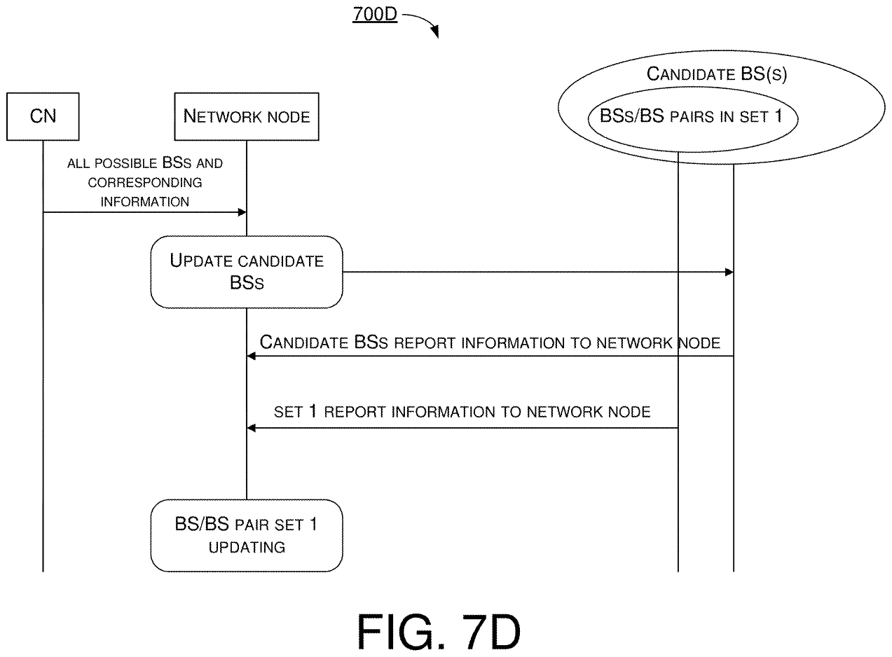

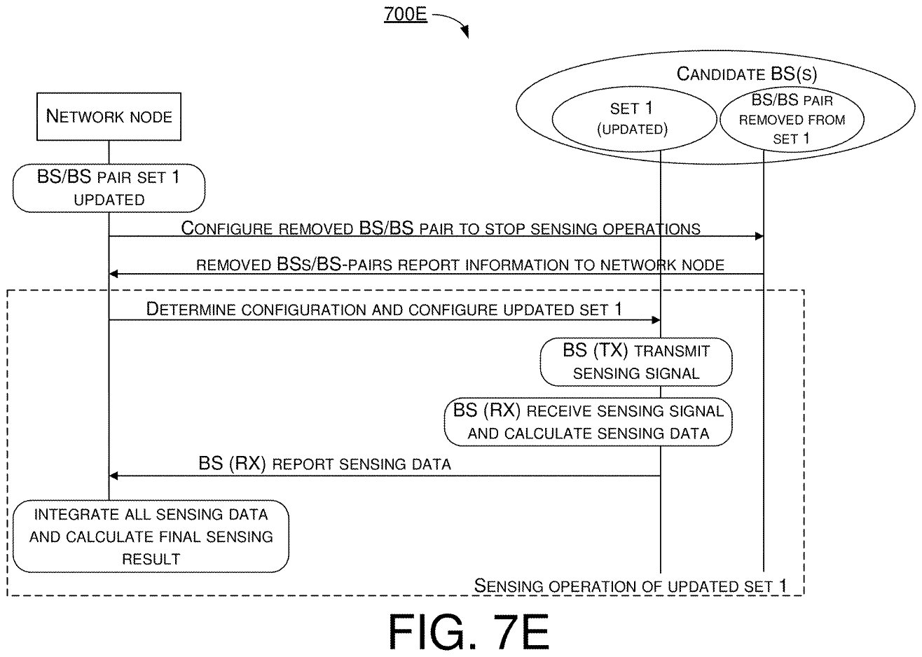

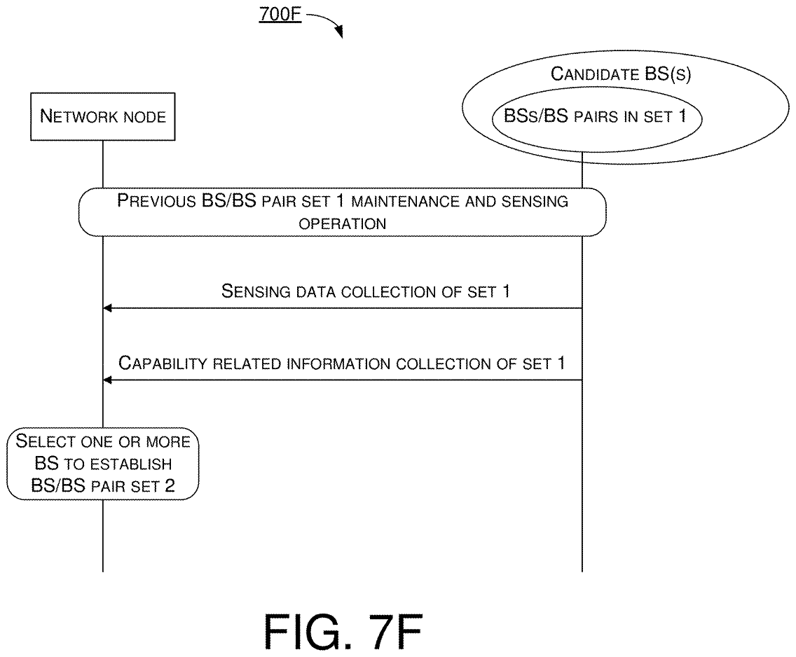

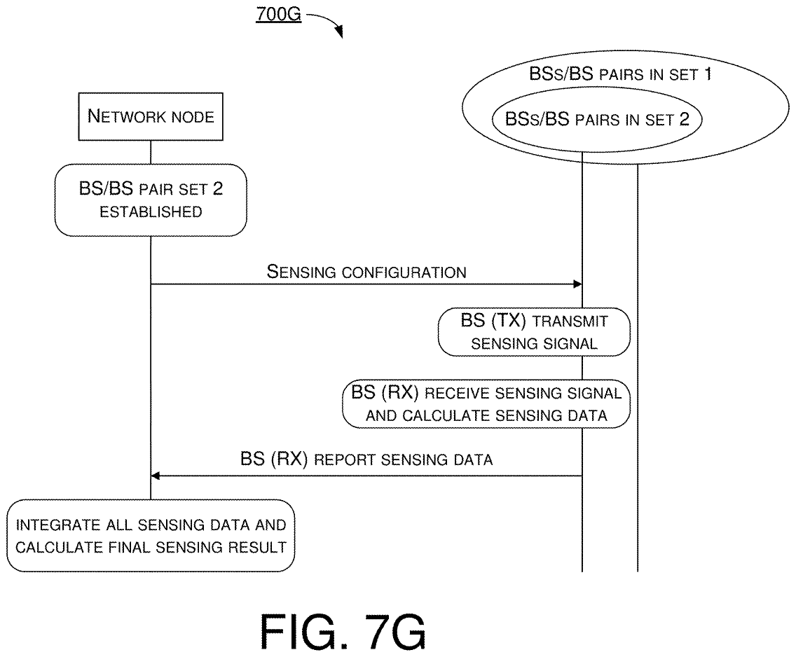

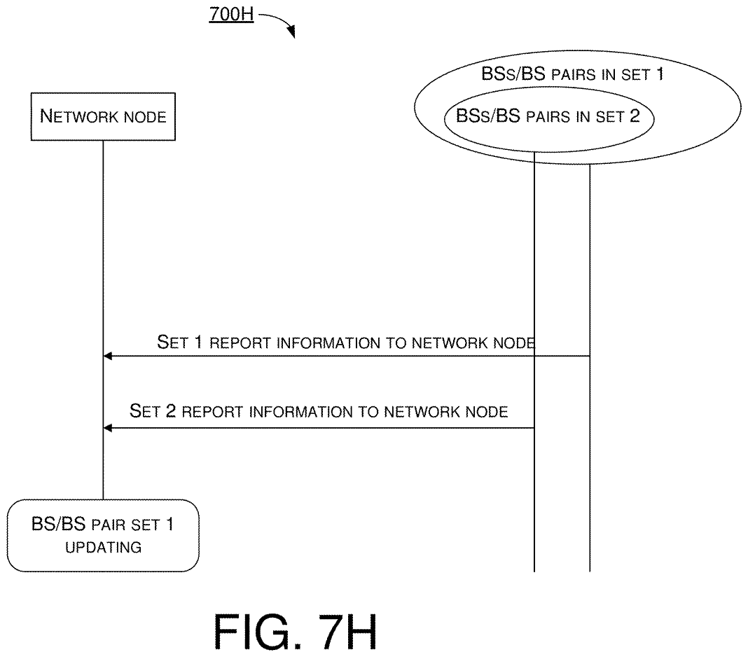

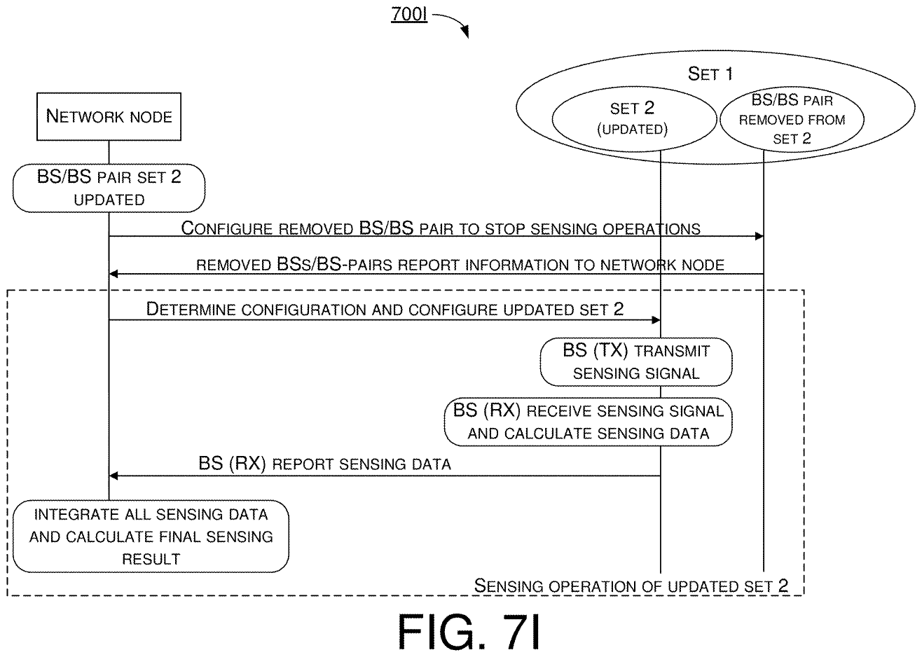

FIG. 7A illustrates an example scenario 700A under schemes in accordance with implementations of the present disclosure. In some implementations, an ISAC system may include a network node having sensing function, a CN and sensing nodes including BSs. The BSs may include: (1) candidate BSs, (2) sensing BSs in set 1 and (3) sensing BSs in set 2.

It should be noted that the network node and the CN are shown as separate entities in FIG. 7A. This illustration is not intended to limit the present disclosure. A person skilled in the art should readily understand that the network node may be implemented as part of the CN, such that the network node and the CN may be the same entity.

In some implementations, there may be interactions between the network node and the sensing BSs. In particular, to each set, there may be steps of: (1) sensing node set establishment, (2) sensing operation of sensing nodes/node-pairs, (3) sensing node set updating, and (4) operation of sensing node switch.

FIG. 7B illustrates an example scenario 700B under schemes in accordance with implementations of the present disclosure. With respect to sensing node set establishment of set 1, after receiving sensing service request, the network node may obtain all possible BSs corresponding information from the CN. In particular, depending on a sensing area, the network node may obtain all possible BSs from the CN (based on the regional information of these BSs). The network node may also obtain detailed information of these BSs from CN, including positions, capabilities, authorizations, etc. The network node may select BS(s) as candidate BSs. The selection may be performed based on the position, capability and/or authorization information of the BSs.

In some implementations, the candidate BSs may report information to the network node. In particular, all candidate BSs may report information to the network node while the information includes sensing capabilities and positions (e.g., more accurate GPS information) of the candidate BSs. The sensing capabilities may include (1) supporting sensing or not, (2) supported sensing quantities, (3) corresponding sensing accuracy and resolution for each measurement quantity, (4) coverage of sensing range, (5) supported sensing mode, (6) whether the BS may act as a sensing TX, a sensing RX, or both, (7) capability of sensing resource configuration, and/or (8) supporting multi-static sensing or not. The reporting may be triggered by the network node.

In some implementations, the network node may select one or more BSs/BS-pairs to establish set 1. In particular, the network node may select one or more BSs/BS-pairs as initial sensing nodes to establish set 1 based on sensing service requirements and the collected information of the candidate BSs. The selection criteria may primarily depend on whether the sensing capabilities and positions of the BSs satisfy the sensing service requirements.

In some cases, for BS bistatic sensing (including multi-static sensing), the network node may need to select one or more BS pairs and to define the role of TX and RX of each pair. In some cases, for multi-static sensing (BS-BSs), some BSs may participate in multiple BS pairs. For example, one BS and corresponding multiple neighbor cell BSs form multiple pairs.

FIG. 7C illustrates an example scenario 700C under schemes in accordance with implementations of the present disclosure. With respect to sensing operation of sensing nodes/node-pairs in set 1, the network node may request and configure every BS/BS-pair in set 1 to start sensing task. Corresponding configuration may include: (1) sensing mode, (2) cooperative device (i.e., BS), (3) role of TX and RX, (4) QoS requirement (accuracy, resolution, latency, etc.), (5) sensing data reporting configuration, (6) suggested sensing signal configuration, and/or (7) indicating sensing signal configuration for RX node.

With respect to the suggested sensing signal configuration, in cooperative sensing scenarios, the network node may coordinate sensing resources across multiple nodes and sensing modes, wherein the nodes may share a common sensing signal or utilize orthogonal sensing signals.

In some implementations, each BS as TX may transmit sensing signals. In particular, each BS as TX may determine detailed sensing resource configuration based on information of the network node. In some cases, the sensing resource configuration may include sensing signal timing, frequency-domain and spatial-domain patterns (e.g., a TX beam), time-domain duration and period, and/or power settings. For example, for target detection, the TX beams of the sensing signal may be configured to cover the entire sensing area. Each BS as TX may transmit sensing signal based on the determined resource configuration. The sensing signal may be periodic, semi-persistent or aperiodic, depending on sensing task requirements.

In some implementations, each BS as RX may receive sensing signal and calculate sensing data. In particular, for BS monostatic sensing, the BS may receive sensing signal transmitted by itself and calculate sensing data. For BS bistatic sensing, the BS as RX may receive sensing signal transmitted by its paired BS (TX). The paired BS (i.e., cooperative BS) and sensing signal configuration may be configured by the network node. For multi-static sensing, one BS (RX) may need to receive sensing signal from multiple neighbor BSs (TXs). The sensing algorithm may include 2D-FFT, MUSIC, IAA, etc.

In some implementations, each BS as RX may report sensing data to the network node. In particular, each BS as RX may report its sensing data to the network node. The report may be periodic or event-trigger report. In some cases, the sensing data may include: (1) required sensing measurement quantities and/or (2) corresponding quality which may be used to determine the reliability of sensing data.

In some implementations, the network node may integrate the sensing data of all BSs/BS-pairs and calculate a final sensing result. In particular, the network node may integrate all results of BSs/BS-pairs and calculate the final sensing result of the sensing service. In some cases, there may be one or more targets. The network node may need target clustering algorithm to match targets with sensing data of each sensing node.

FIG. 7D illustrates an example scenario 700D under schemes in accordance with implementations of the present disclosure. With respect to sensing node set updating to set 1, the network node may obtain all possible BSs and corresponding information from the CN. In particular, since location of target, position of BS and BS capability may change, the network node may need to obtain updated possible BSs and corresponding information. The updating may be periodic, or event-trigger by the network node or the BSs. The network node may select BS for updating candidate BSs. The selection may be performed based on the updated BSs and corresponding information.

In some implementations, the candidate BSs may report information to the network node. In particular, all candidate BSs may report information to the network node while the information includes sensing capabilities and positions (e.g., more accurate GPS information) of the candidate BSs. The sensing capabilities may include (1) supporting sensing or not, (2) supported sensing quantities, (3) corresponding sensing accuracy and resolution for each measurement quantity, (4) coverage of sensing range, (5) supported sensing mode, (6) whether the BS may act as a sensing TX, a sensing RX, or both, (7) capability of sensing resource configuration, and/or (8) supporting multi-static sensing or not. The reporting may be triggered by the network node.

In some implementations, the BSs of set 1 may report information to the network node. In particular, the network node may collect sensing data and corresponding quality information of BSs/BS-pairs in set 1. In some cases, the information may be: (1) whether the BS/BS-pair may detect the target, and (2) whether quality of sensing result is good. The information may be reported periodically by the BSs, or may be reported aperiodically in response to a trigger from the network node or from the BSs themselves (e.g., when sensing data or sensing quality changes). In some cases, the target is UE, and a serving cell BS is the sensing BS or one of sensing BSs. In these cases, when UE handover occurs, the previous serving cell BS may inform the network node to update set 1.

In some implementations, the network node may update BSs/BS-pair in set 1. In particular, the network node may update BSs/BS-pair in set 1 based on the collected information. The updating may include: (1) selecting new BSs/BS-pairs from candidate BSs to be added into set 1, (2) removing original BSs/BS-pairs from set 1, (3) role reversal of TX and RX of BS-pair, and/or (4) change of TX or RX of BS-pair.

In some cases, some BSs/BS-pairs may be closer to the target or sensing capability exhibit improved sensing capability. These BSs/BS-pairs may be added into set 1. In some cases, sensing capability of some original BSs/BS-pairs may experience degraded sensing capability or have poor sensing quality. These BSs/BS-pairs may be removed from set 1. In some cases, a target (which is also UE) is sensed by its own serving cell BS. When UE handover occurs, the network node may update the sensing BS from the previous serving cell BS to a new serving cell BS.

FIG. 7E illustrates an example scenario 700E under schemes in accordance with implementations of the present disclosure. With respect to operation of sensing node switch in set 1, the network node may configure the removed BSs/BS-pairs to stop sensing operations.

In some implementations, the removed BSs/BS-pairs may report information to the network node when necessary. In some cases, before the BS stopping sensing operation, the BS may need to report some information to the network node (e.g., sensing resource configuration, sensing result, etc.). The network node may configure what to report. The information may be used as reference for the configuration of BSs in the updated set 1.

In some implementations, the network node may determine configurations and configure the BSs/BS-pairs in the updated set 1 to start sensing operations. The configuration may be similar as that of step of sensing operation of sensing nodes/node-pairs in FIG. 7C, such as (1) sensing mode, (2) cooperative device (i.e., BS), (3) role of TX and RX, (4) QoS requirement (accuracy, resolution, latency, etc.), (5) sensing data reporting configuration, (6) suggested sensing signal configuration, and/or (7) indicating sensing signal configuration for RX node.

In some cases, there may be differences. In particular, the network node may collect some information (information of target, sensing resource configuration information, etc.) from BSs in the original set 1. The information may be used to determine the configuration (e.g., a suggested sensing signal configuration) of newly added BSs and of BSs that remain in the updated set 1. For the BSs that remain in the updated set 1, the configuration may need to be revised; for example, their cooperative BS changes, or their TX or RX roles is altered.

In some implementations, the BS as TX may transmits sensing signals. The transmissions of sensing signals may be similar as that of step of sensing operation of sensing nodes/node-pairs in FIG. 7C.

In some cases, there may be differences. In particular, for newly added BSs and BSs that remain in the updated set 1, these BSs may determine sensing signal configuration based on suggestion from the network node (which may be decided from the information of BSs in the original set 1). For BSs that remain in the updated set 1, sensing signal configuration may be adjusted based on the previous sensing results.

In some implementations, the BS as RX may receive sensing signal and calculate sensing data. The receptions of sensing signals may be similar as that of step of sensing operation of sensing nodes/node-pairs in FIG. 7C.

In some cases, there may be differences. In particular, for newly added BSs, sensing data of BSs in the original set 1 may be used to assist to calculate sensing data.

In some implementations, the BS as RX may report sensing data to the network node, and the network node may integrate all sensing data and calculate a final sensing result. The report of the sensing data, the integration of sensing data and the calculation of the final sensing result may be similar as those of step of sensing operation of sensing nodes/node-pairs in FIG. 7C.

It should be noted that, in FIG. 7E, the dotted-line frame may represent the sensing operations performed by the BSs/BS-pairs in the updated set 1.

FIG. 7F illustrates an example scenario 700F under schemes in accordance with implementations of the present disclosure. With respect to sensing node set establishment to set 2, the network node may collect sensing data of BSs/BS-pairs of set 1. The sensing data may include whether the target is detected or not, target related parameters, sensing result quality, etc. The sensing results may be reported periodically by the BSs, or may be reported aperiodically in response to a trigger from the network node or from the BSs themselves (e.g., when a new target is detected).

In some implementations, the network node may collect capability related information of BSs/BS-pairs of set 1. The sensing capability information may include whether the BS supports target tracking or higher precision requirement task, etc. In some cases, with respect to the position information of the BSs, since the network node may already have the position information of the BSs in set 1 from the CN, the network node may not need to request the position information from the CN again. The information may be reported periodically by the BSs, or may be reported aperiodically in response to a trigger from the network node or from the BSs themselves (e.g., when a capability changes).

In some implementations, the network node may select one or more BSs to establish set 2. In particular, the network node may select one or more BSs/BS-pairs from BSs/BS-pairs in set 1 to establish set 2 based on sensing service requirements and the collected information of BSs of set 1 (including sensing result, capability and/or position information). The criteria of selection may include that: (1) the BS/BS-pair may detect target, (2) sensing quality may be good, (3) distance between the BS's/BS-pair and target may meet requirement, and/or (4) the BS may have capability to support tracking or high precision sensing.

FIG. 7G illustrates an example scenario 700G under schemes in accordance with implementations of the present disclosure. With respect to the sensing operation of the sensing nodes or node-pairs in set 2, since the BSs in set 2 may also belong to set 1, the BSs may need to perform both the sensing tasks of set 1 and the sensing tasks of set 2. The two sensing tasks may be configured and performed together or separately, including configuration, sensing signal transmission, signal reception, and processing at the RX node.

It should be noted that, for simplicity, the following description refers only to the sensing operations for the BSs in set 2. In addition, the detailed operations may be similar to those of the BSs in set 1. The differences may include that the configurations and sensing results of the BSs in set 1 may be used to assist the operations of the BSs in set 2. The following description therefore focuses only on the differences relative to the operations of the BSs in set 1.

In some implementation, the sensing results and signal resource configuration of BSs in set 1 may be used as reference in the configuration. In some cases, location/direction and number of detected target may be used to determine the suggested sensing signal configuration.

In some implementations, the BS as TX may transmit sensing signals. The sensing signal resource configuration of BSs in set 1 may be used as reference in the resource configuration. In some cases, TX beam (corresponding to the detected target) of BS in set 1 may be used to assist TX beam configuration of BS in set 2.

In some implementations, the BS as RX may receive the sensing signal and calculate sensing data. Some prior information may be used during signal reception and sensing data calculation. During the operation of the BSs in set 1 (e.g., target detection), a TX-RX beam-pair link (BPL) corresponding to the detected target may be obtained. The RX beam associated with the detected target may be used for RX beam selection by the BS in set 2 for the task of target tracking. In addition, coarse target information computed by a BS in set 1 may be used as an initial value or as auxiliary information in the sensing data calculation performed by a BS in set 2.

In some implementations, the BS as RX may report sensing data to the network node. The network node may integrate sensing data of all BSs/BS-pairs and calculate the final sensing result.

FIG. 7H illustrates an example scenario 700H under schemes in accordance with implementations of the present disclosure. With respect to sensing node set updating to set 2, the BSs of set 1 may report information to the network node. The network node may collect sensing data (and corresponding quality information) and other set 1 updating information from the BSs or BS-pairs in set 1. Such information may be reported periodically by the BSs, or may be reported aperiodically in response to a trigger from the network node or from the BSs themselves (e.g., when a new target is detected, when the original target is missed, or when set 1 is updated, such as when certain BSs or BS-pairs that also belong to set 2 are removed from set 1).

In some implementations, the BSs of set 2 may report information to the network node. In particular, the network node may collect sensing data (and corresponding quality information) and sensing capability updating information from the BSs or BS-pairs in set 2. The information may be reported periodically by the BSs, or may be reported aperiodically in response to a trigger from the network node or from the BSs themselves (e.g., when the original target is missed, when sensing quality degrades, or when a node no longer has the capability to support the task for the BSs in set 2).

In some implementations, the network node may update BSs/BS-pairs in set 2. In particular, the network node may update BSs/BS-pairs in set 2 based on the collected information. The updating may include: (1) selecting new BSs/BS-pairs from set 1 to be add into set 2, and/or (2) removing the original BSs/BS-pairs from set 2. In some cases, some BSs/BS-pairs may be closer to the target and may detect the target with better sensing quality. Such BSs/BS-pairs may be added to set 2. In some cases, the sensing capabilities of some BSs may degrade, the sensing quality may become insufficient, or the BSs may become farther from the target. Such BSs may be removed from set 2. In some cases, some BSs/BS-pairs may be removed from set 1, and such BSs/BS-pairs may be removed from set 2.

FIG. 7I illustrates an example scenario 700I under schemes in accordance with implementations of the present disclosure. With respect to operation of sensing node switch in set 2, the network node may configure the removed BSs/BS-pairs to stop sensing operations. In some cases, since the removed BSs/BS-pairs may still belong to set 1, the sensing operations for the BSs in set 1 may remain ongoing.

In some implementations, the operation of sensing node switch in set 2 may be similar as that of step of the operation of sensing node switch in set 1 in FIG. 7E.

In some implementations, the sensing node(s) may include one or more BS-UE pairs. Sensing mode may be BS-UE bistatic sensing based on DL or UL sensing signal, including multi-static sensing (e.g., BSs-UE or BS-UEs).

In some cases, for multi-static sensing (BS-UEs), the procedure and operation may be similar to those of BS-UE bistatic sensing. In some cases, for multi-static sensing (BSs-UE): (1) the UE may receive DL sensing signals from multiple BSs, rather than only from the serving cell (e.g., similar to Positioning Reference Signal (PRS) transmission for positioning); and (2) UL sensing signals transmitted by the UE may be received by multiple BSs, rather than only by the serving cell (e.g., similar to Sounding Reference Signal (SRS) reception for positioning).

In some cases, multi-static sensing may be supported in both the first sensing node set and the third sensing node set, or only in the first sensing node set. In some cases, for target detection, the sensing signals may be cell-specific, and multi-static sensing (BSs-UE) may be supported. In some cases, for target tracking, the sensing signals may be direction-specific, making multi-static sensing more complicated to support. Nonetheless, BSs may transmit multiple fine beams simultaneously to support such a scenario.

In some cases, for single-stage type scenario, the first sensing node set may be maintained. According to the sensing area and candidate BS/UE sensing capability, the initial sensing BS-UE pairs may be determined, which includes the establishment of the first sensing node set. The first sensing node set may be updated based on sensing results of sensing BS-UE pairs in the first sensing node set, sensing capability changes of candidate BSs and UEs or position change of UEs.

In some cases, for two-stage type scenario, the first sensing node set and the third sensing node set may be maintained. The maintenance of the first sensing node set may be the same as that of single-stage type scenario. When some sensing BS-UE pairs in the first sensing node set detect the target(s), the network node may select some BS-UE pairs to track the target(s) (may use different sensing resources than detection). These selected sensing BS-UE pairs may be added into the third sensing node set which may be a subset of the first sensing node set.

In some cases, (1) since the target(s) may be moving, (2) the capabilities of the sensing BS-UE may be also changing, and (3) sensing BS-UE pairs in the first sensing node set may find new targets, the third sensing node set may be constantly updated.

In some cases, each BS-UE pair may support DL-only sensing, uplink UL-only sensing, or both DL and UL sensing. Support for DL and UL sensing may depend on the capabilities of the BS and the UE, which may be reported to the network node. In some cases, performing DL and UL sensing simultaneously may improve sensing performance.

In some cases, with respect to relationship with communication handover, UE may be the sensing node. When an original serving cell BS and a UE form a BS-UE-pair, the pair may be updated along with UE handover. In addition, sensing configuration information of UE (e.g., neighbor cell BS list and corresponding sensing signal configuration) may also be configured by a new serving cell BS. When the original serving cell BS and the new serving cell BS do not form a BS-UE-pair with the UE, the sensing configuration information of the UE may also be configured by the new serving cell BS.

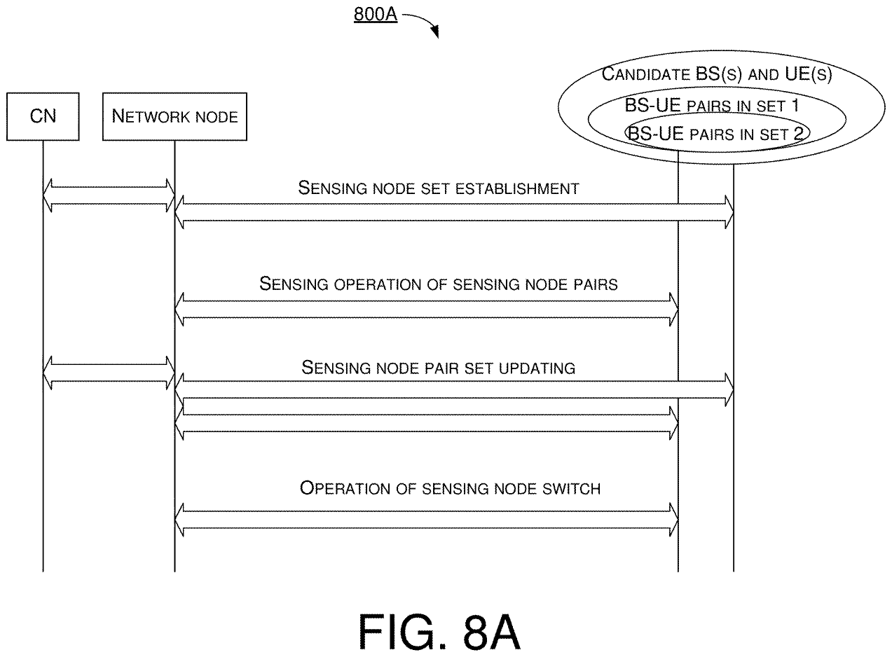

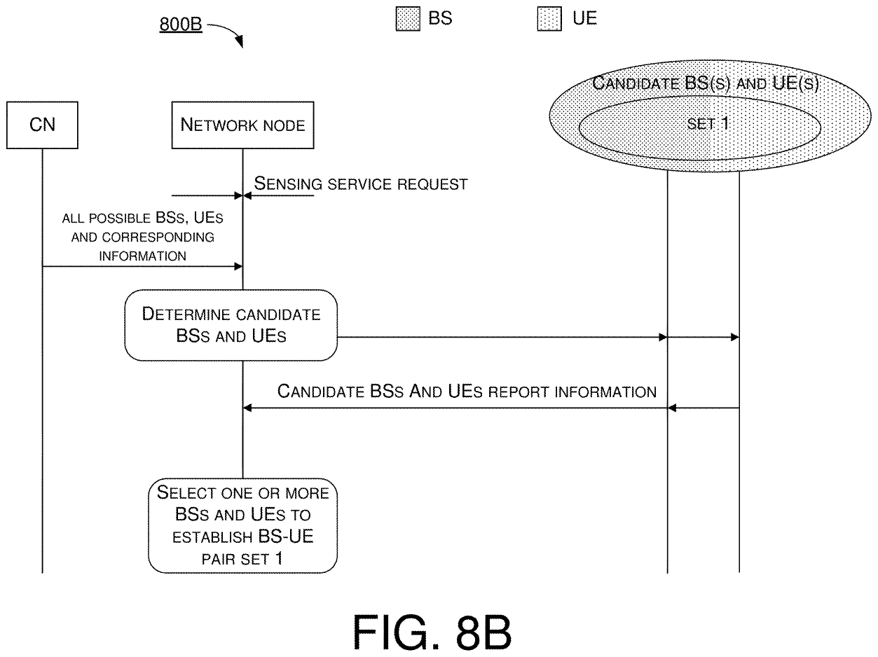

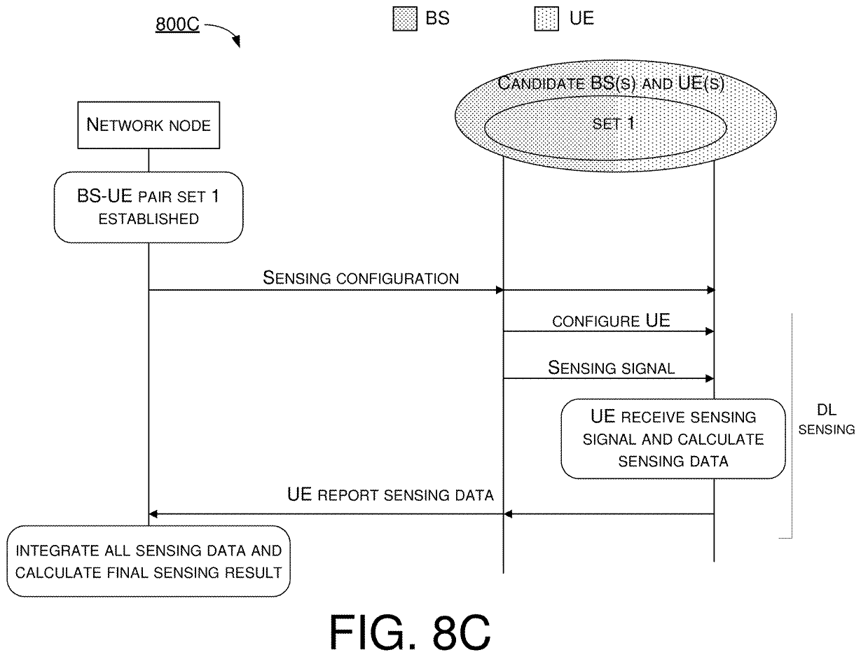

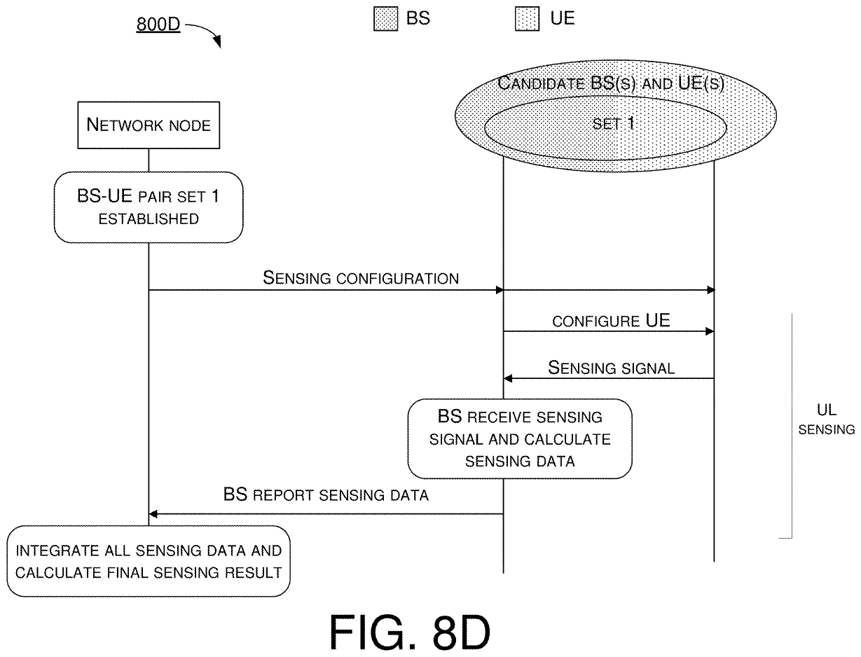

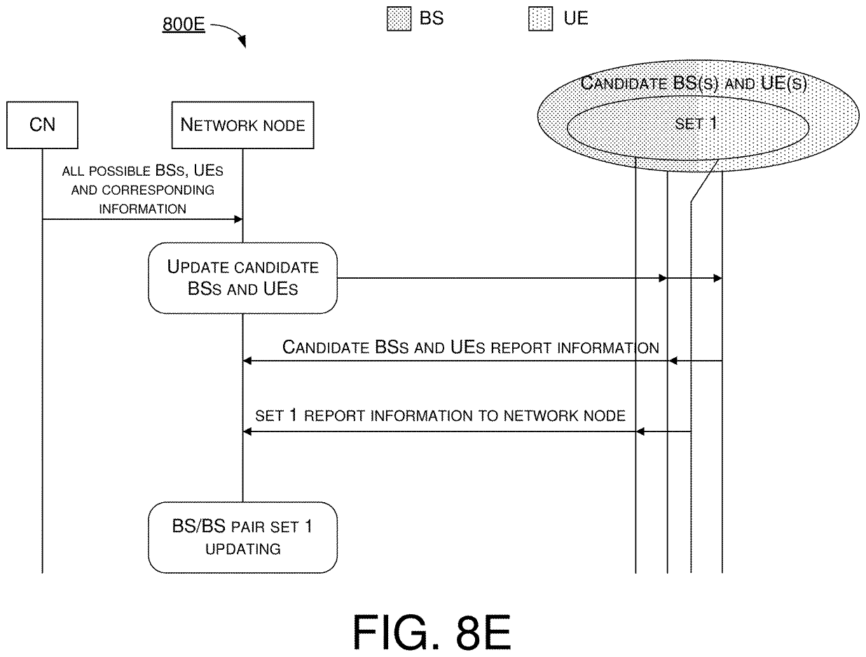

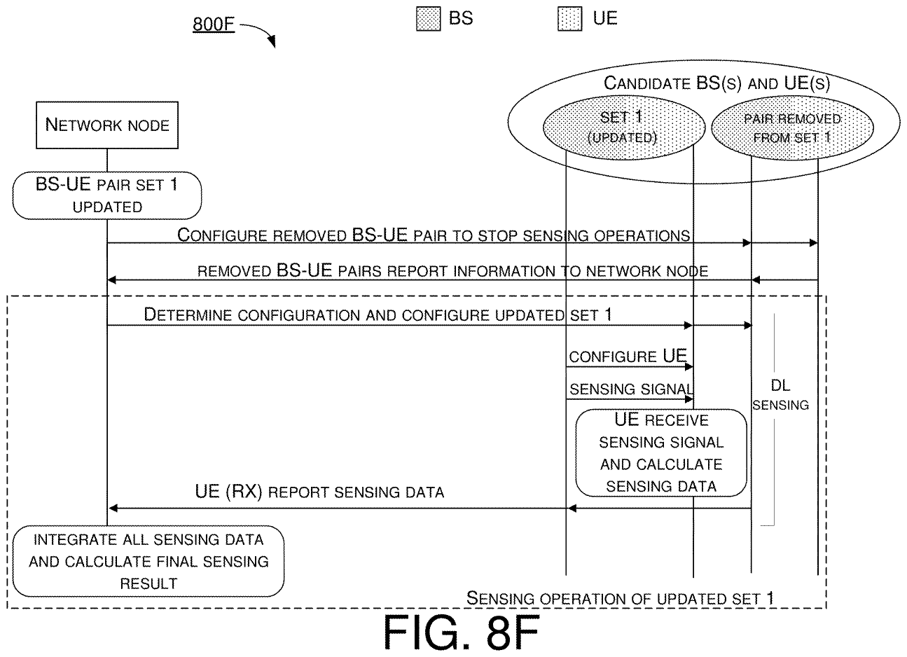

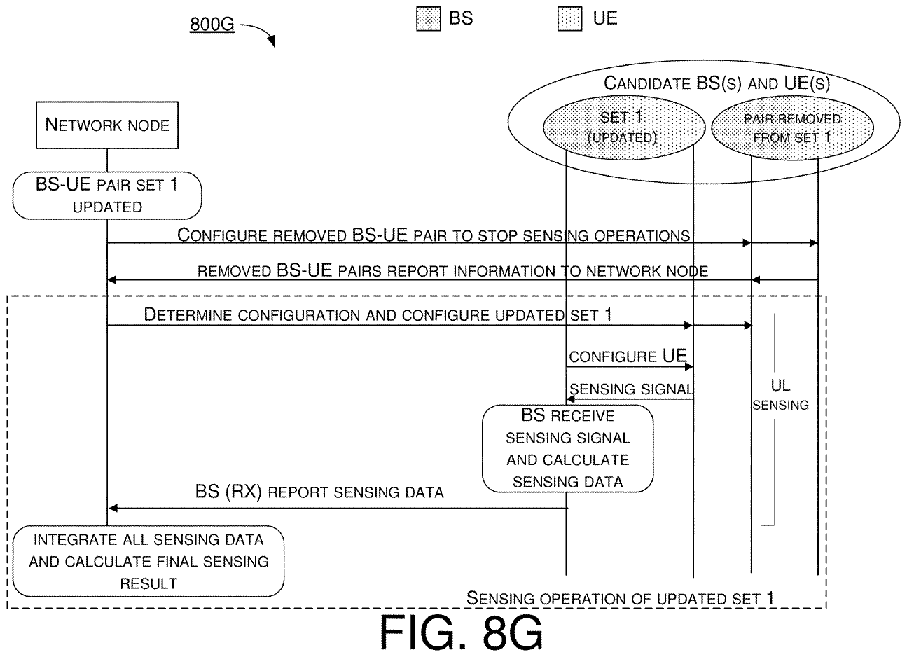

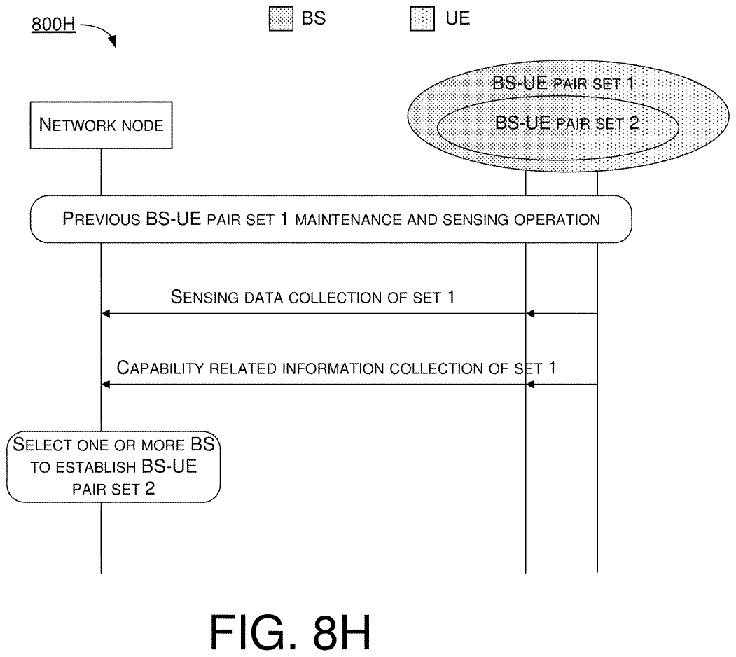

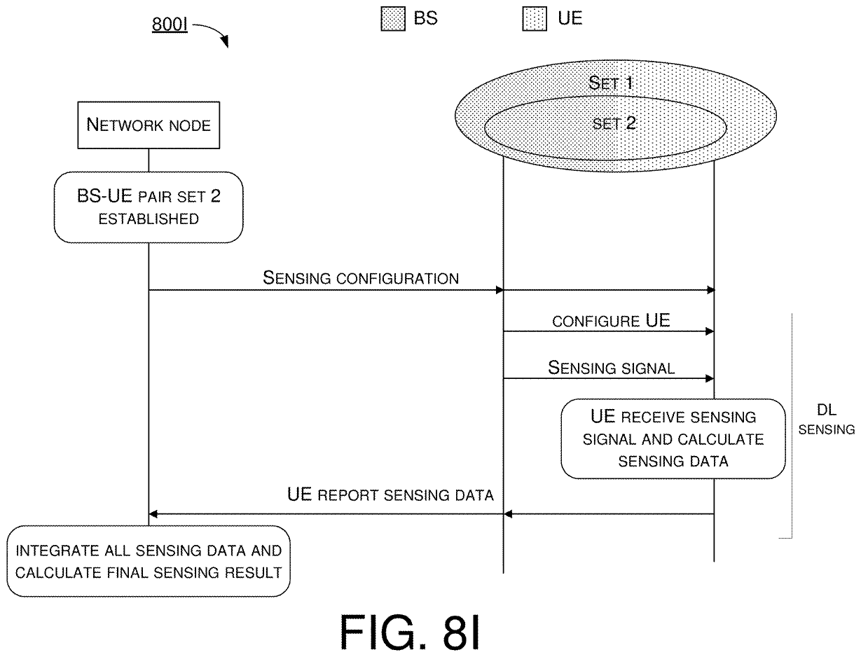

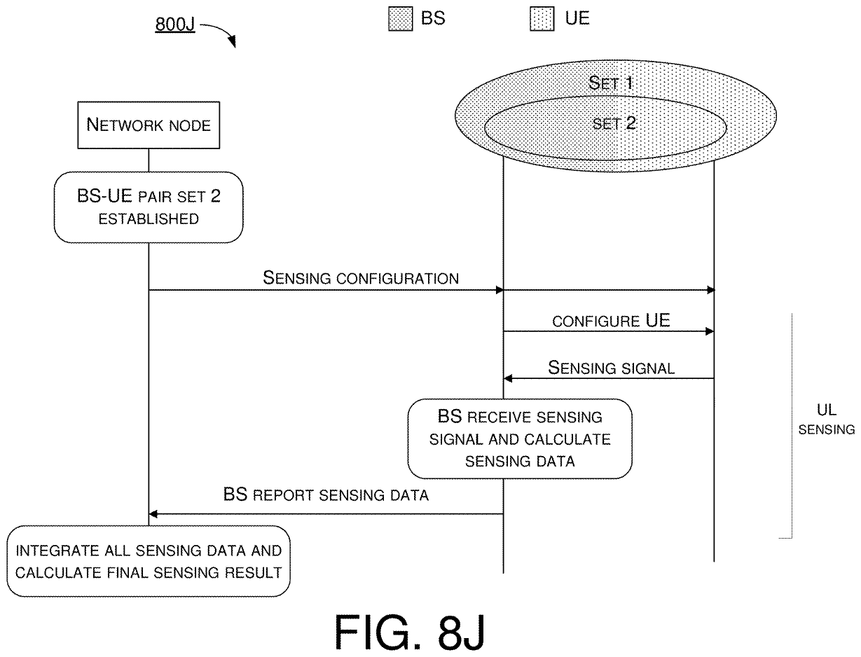

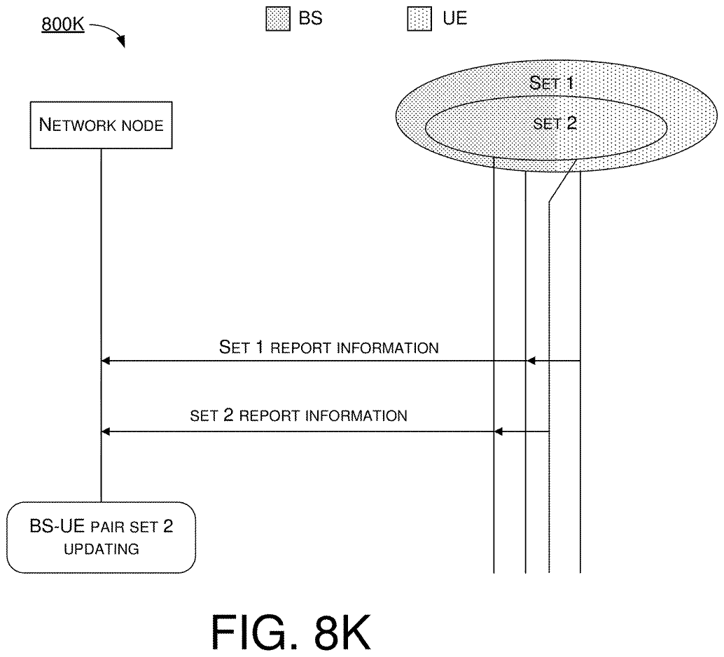

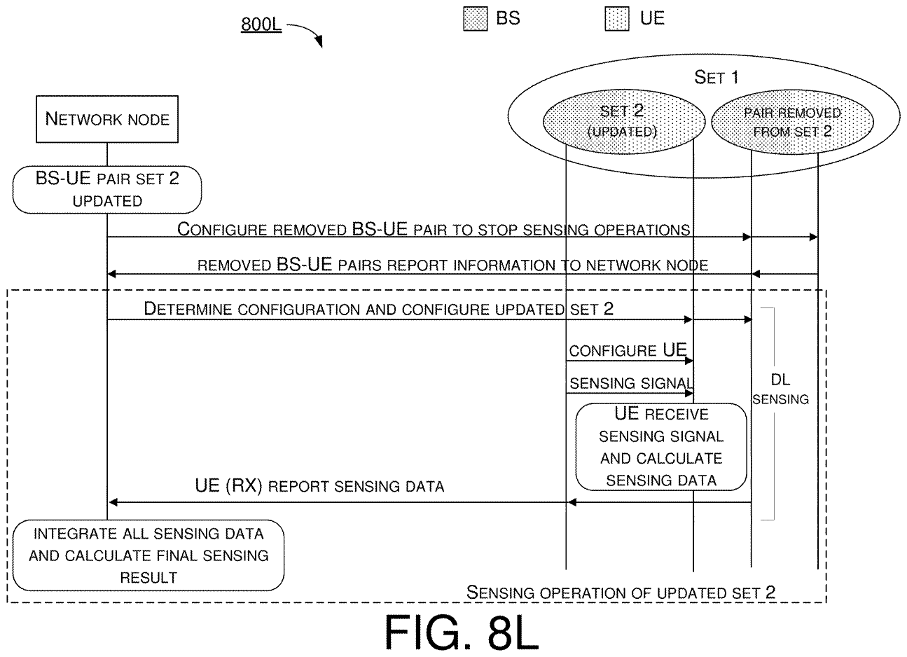

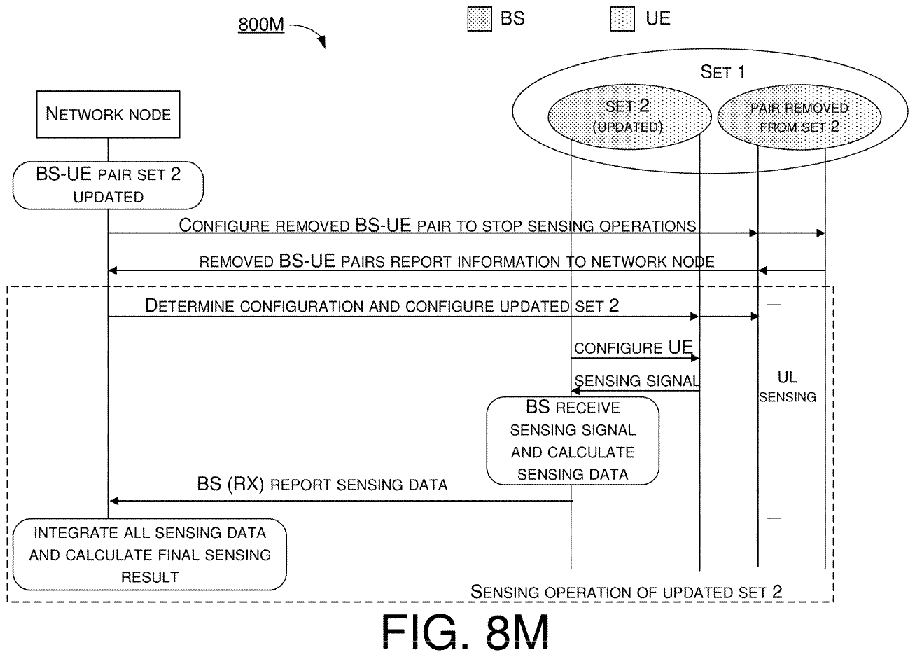

FIG. 8A illustrates an example scenario 800A under schemes in accordance with implementations of the present disclosure. In some implementations, an ISAC system may include a network node having sensing function, a CN and sensing nodes including BSs and UEs. The BSs and the UEs may include candidate BSs and UEs forming (1) sensing BS-UE pairs in set 1 and (3) sensing BS-UE pairs in set 2.

It should be noted that the network node and the CN are shown as separate entities in FIG. 8A. This illustration is not intended to limit the present disclosure. A person skilled in the art should readily understand that the network node may be implemented as part of the CN, such that the network node and the CN may be the same entity.

In some implementations, there may be interactions between the network node and the sensing BS-UE pairs. In particular, to each set, there may be steps of: (1) sensing node-pair set establishment, (2) sensing operation of sensing node-pairs, (3) sensing node-pair set updating, and (4) operation of sensing node-pair switch.

FIG. 8B illustrates an example scenario 800B under schemes in accordance with implementations of the present disclosure. With respect to sensing node set establishment of set 1, after receiving sensing service request, the network node may obtain all possible BSs, UEs and corresponding information from the CN. In particular, depending on a sensing area, the network node may obtain all possible BSs and UEs from the CN (based on the regional information of these BSs and UEs). The network node may also obtain detailed information of these BSs and UEs from CN, including positions, capabilities, authorizations, etc. The network node may select BS(s) and UE(s) as candidate BSs and UEs. The selection may be performed based on the position, capability and/or authorization information of the BSs and UEs.

In some implementations, the candidate BSs and UEs may report information to the network node. In particular, all candidate BSs and UEs may report information to the network node while the information includes sensing capabilities, positions information (e.g., more accurate GPS information) of the candidate BSs and UEs, and signal quality information.

In some cases, the sensing capabilities may include (1) supporting sensing or not, (2) supported sensing quantities, (3) corresponding sensing accuracy and resolution for each measurement quantity, (4) coverage of sensing range, (5) supported sensing mode, (6) whether the BS/UE may act as a sensing TX, a sensing RX, or both, (7) capability of sensing resource configuration, and/or (8) supporting multi-static sensing (BSs-UE or BS-UEs) or not. The reporting may be triggered by the network node. In some cases, the position information may include (1) GPS information, and/or (2) positioning (DL or UL) related information. In some cases, the signal quality information may include DL or UL communication link quality between BS and UE (e.g., RSSI/RSRP/RSRQ/SNR measured by UE or BS). In some cases, the reporting may be requested by the network node (e.g., the network node may request the UE through corresponding serving cell BS, and the UE may report to the network node through the serving cell BS).

In some implementations, the network node may select one or more BSs/BS-pairs to establish set 1. In particular, the network node may select one or more BS-UE pairs as initial sensing node pairs to establish set 1 based on sensing service requirements and the collected information of the candidate BSs and UEs. The selection criteria may primarily depend on whether the sensing capabilities, positions information and the signal quality information of the BSs and UEs satisfy the sensing service requirements.

In some cases, after establishment of set 1, the network node may have BS and UE matching information and information of roles of TX and RX of each pair. The information may be used in sensing configuration. Each BS may have a corresponding group of UEs for sensing signal transmission and/or reception. Each UE may have a corresponding group of BSs for sensing signal transmission and/or reception.

In some cases, when BS and UE support multi-static sensing (BSs-UE or BS-UEs), some BSs and UEs may appear in more than one BS-UE pairs. For example, BS and multiple UEs which may be in a cell form multiple pairs (BS-UEs pairs). For another example, UE and multiple BSs (serving cell BS and neighbor cell BSs) form multiple pairs (BSs-UE pairs).

In some cases, the UE and the corresponding serving cell BS may not need to form a pair. For example, when the serving cell BS is heavily loaded and cannot support the sensing operation, the UE may instead form BS-UE pairs with one or more neighboring cells of BSs.

FIGS. 8C and 8D illustrate example scenarios 800C and 800D under schemes in accordance with implementations of the present disclosure. With respect to sensing operation of sensing node-pairs in set 1, the network node may request and configure every BS-UE pair in set 1 to start sensing task. The network node may configure the BS(s) and the UE(s) separately. For each UE, the network node may configure the UE through corresponding serving cell BS.

Corresponding configuration may include: (1) sensing mode, (2) cooperative device (i.e., BS or UE), (3) role of TX and RX, (4) QoS requirement (accuracy, resolution, latency, etc.), (5) sensing data reporting configuration, (6) suggested sensing signal configuration, and/or (7) indicating sensing signal configuration for RX node.

With respect to the suggested sensing signal configuration, in cooperative sensing scenarios, the network node may coordinate sensing resources across multiple nodes and sensing modes, wherein the nodes may share a common sensing signal or utilize orthogonal sensing signals.

In some implementations, for each BS-UE pair, BS-UE pair may need to perform DL sensing (as shown in FIG. 8C), UL sensing (as shown in FIG. 8D), or both DL and UL sensing.

In some implementations, with respect to DL sensing, each BS as TX may determine detailed DL sensing signal and resource. The serving cell BSs may configure the information to the UEs.

In some cases, the DL sensing resource configuration may include sensing signal timing, frequency-domain and spatial-domain patterns (e.g., a TX beam), time-domain duration and period, and power settings. For example, for target detection, the BS TX beams of the sensing signal may be configured to cover the entire sensing area.

In some cases, for multi-static sensing (BSs-UE), sensing configuration of the UE may include sensing signal configurations of all BSs which may be paired with this UE. In some cases, the serving cell BS may not be a sensing BS.

In some cases, each BS as TX may transmit a sensing signal to the UEs with which the BS may be paired, based on the determined sensing signal resource configuration. The sensing signal may be periodic, semi-persistent, or aperiodic, depending on the requirements of the sensing task.

In some cases, each UE as RX may receives sensing signal and calculate sensing data. Each UE may perform bistatic sensing related operations (as sensing RX) with paired BSs. In addition to the sensing operations (e.g., target detection and estimation with 2D-FFT, MUSIC, IAA algorithm), the related operations (e.g., synchronization operation) may also be included. For multi-static sensing (BSs-UE), one UE as RX may need to receive sensing signal and perform bistatic sensing with multiple BSs as TXs.

In some cases, each UE as RX may report sensing data to the network node. The report may be periodic or event-trigger report. The sensing data may include the required sensing measurement quantities and/or corresponding quality which may be used to judge the reliability of sensing data.

With respect to UL sensing, each BS may determine detailed UL sensing signal and resource. The serving cell BSs may configure the information to UEs. This step may be similar to that of DL sensing, with the difference being that UL signal resources are determined and configured.

In some cases, each UE as TX may transmit a sensing signal to the BSs with which the UE may be paired, based on the determined sensing signal resource configuration. The sensing signal may be periodic, semi-persistent, or aperiodic, depending on the requirements of the sensing task.

In some cases, each BS as RX may receive sensing signal and calculate sensing data. Each BS may perform bistatic sensing related operations (as sensing RX) with paired UEs. In addition to the sensing operations (e.g., target detection and estimation with 2D-FFT, MUSIC, IAA algo), the related operations (e.g., synchronization operation) may also be included. For multi-static sensing (BS-UEs), each BS may need to receive UL sensing signal from multiple UEs. For multi-static sensing (BSs-UE), one transmission signal from UE may be received by multiple BSs.

In some cases, each BS as RX may report sensing data to the network node. The report may be periodic or event-trigger report. The sensing data may include the required sensing measurement quantities and corresponding quality which may be used to judge the reliability of sensing data.

In some implementations, the network node may integrate the sensing data of all BS-UE pairs and calculate a final sensing result. In particular, the network node may integrate all results of BS-UE pairs and calculate the final sensing result of the sensing service. In some cases, there may be one or more targets. The network node may need target clustering algorithm to match targets with sensing data of each sensing node.

FIG. 8E illustrates an example scenario 800E under schemes in accordance with implementations of the present disclosure. With respect to sensing node set updating to set 1, the network node may obtain all possible BSs, UEs and corresponding information from the CN. In particular, since location of target, positions of BSs/UEs, and BSs/UEs capability may change, the network node may need to obtain updated possible BSs, UEs and corresponding information. The updating may be periodic, or event-trigger by the network node or the BSs/UEs. The network node may select BS(s) and/or UE(s) for updating candidate BSs and UEs. The selection may be performed based on the updated BSs, UEs and corresponding information.

In some implementations, the candidate BSs and UEs may report information to the network node. This may be similar as that of step of sensing node set establishment in FIG. 8B.

In some implementations, the BSs and UEs of set 1 may report information to the network node. In particular, the network node may collect sensing data and corresponding quality information of BS-UE pairs in set 1. In some cases, the information may be: (1) whether the BS-UE pair may detect the target, and (2) whether quality of sensing result is good. The information may be reported periodically by the BSs and UEs, or may be reported aperiodically in response to a trigger from the network node or from the BSs and UEs themselves (e.g., when sensing data or sensing quality changes). In some cases, the UE (sensing node) handover occurs. In these cases, when the original serving cell BS and UE form a BS-UE pair, the pair may be updated along with UE handover. In addition, sensing configuration information of the UE. (e.g., neighbor cell BSs list and corresponding sensing signal configuration) may also be configured by the new serving cell BS. When the original and new serving cell BSs do not form a BS-UE-pair with UE, the sensing configuration information of the UE may also be configured by the new serving cell BS.

In some implementations, the network node may update BS-UE pair in set 1. In particular, the network node may update BS-UE pair in set 1 based on the collected information. The updating may include: (1) selecting new BS-UE pairs from candidate BSs and UEs to be added into set 1, (2) removing original BS-UE pairs from set 1, (3) role reversal of TX and RX of BS-UE pair, and/or (4) change of TX or RX of BS-UE pair.

In some cases, some BS-UE pairs may be closer to the target or sensing capability exhibit improved sensing capability. These BS-UE pairs may be added into set 1. In some cases, sensing capability of some original BS-UE pairs may experience degraded sensing capability or have poor sensing quality. These BS-UE pairs may be removed from set 1. In some cases, positions of some UE may be changed and become farther from target. The related BS-UE pairs may be removed from set 1. In some cases, when UE (sensing node) handover occurs, the previous serving cell BS may not be suitable to form a pair with UE. The new serving cell BS may be suitable to form a new pair with UE.

FIGS. 8F and 8G illustrate example scenarios 800F and 800G under schemes in accordance with implementations of the present disclosure. With respect to operation of sensing node switch in set 1, the network node may configure the removed nodes (i.e., BSs, UEs and BS-UE pairs) to stop sensing operations. In some cases, some nodes may change TX and RX role, and the nodes may stop the original TX or RX operation. The network node may configure UE through serving cell BS.

In some implementations, the removed nodes (i.e., BSs, UEs or BS-UE pairs) may report information to the network node when necessary. In particular, before the BS and UE stop the sensing operation, the BS and UE may report some information to the network node (e.g., sensing resource configuration, sensing results, etc.). The network node may configure which information to be reported. The BS and the UE may report the information to the network node separately. Such information may be used as a reference for configuring the BS-UE pairs in the updated set 1. In some cases, the removed nodes may include a BS only, a UE only, or a BS-UE pair. For different scenarios, the reporting procedures and reported information may differ and may be designed separately.

In some implementations, the network node may determine configurations and configure BS-UE pairs in the updated set 1 to start sensing operations. The configuration may be similar as that of step of sensing operation of sensing node-pairs. The following description therefore focuses only on the differences.

The network node may collect some information (target's information, sensing resource configuration information, etc.) from BS-UE pairs in the original set 1. The information may be used to determine the configuration (e.g., suggested sensing signal configuration) of newly added BS-UE pairs and BS-UE pairs which remain in set 1.

In some cases, for BSs and UEs which remain in set 1, the configuration may need to be updated (e.g., when their cooperative device is changed or role of RX and RX is changed).

In some cases, when the updating of BS-UE pair occurs because of UE handover, the network node may obtain sensing configuration of the UE from the previous serving BS and assist the new serving cell BS to determine sensing configuration. Then the new serving cell BS may transmit the configuration to UE.

In some implementations, the BS may configure UE, BS/UE (TX) to transmit sensing signals. The operation may be similar to that of sensing operation of sensing node-pairs. The following description therefore focuses only on the differences.

For newly added BS-UE pairs and BS-UE pairs which remain in set 1, the BS may determine sensing signal configuration based on suggestion from the network node (which may be decided from the information of BS-UE pairs in the original set 1). For BS-UE pairs which remain in the set 1, sensing signal configuration may be adjusted based on the previous sensing results.

In some implementations, the BS/UE may receive sensing signal and calculate sensing data. The operation may be similar to that of sensing operation of sensing node-pairs. The following description therefore focuses only on the differences.

For newly added BSs and UEs, sensing data of BS-UE pairs in the original set 1 may be used to assist to calculate sensing data, and the rest may be the same as that of sensing operation of sensing node-pairs in FIG. 8D.

FIG. 8H illustrates an example scenario 800H under schemes in accordance with implementations of the present disclosure. With respect to sensing node set establishment to set 2, the network node may collect sensing data of BS-UE pairs of set 1. The sensing data may include whether the target is detected or not, target related parameters, sensing result quality, etc. The sensing results may be reported periodically by the BSs and UEs, or may be reported aperiodically in response to a trigger from the network node or from the BSs and UEs themselves (e.g., when a new target is detected).

In some implementations, the network node may collect capability related information of BS-UE pairs of set 1. The sensing capability information may include whether the BS and UE support target tracking or higher precision requirement task, etc. In some cases, target tracking may require sensing signal with specific beam directions, and neighboring cell BSs may not be able to transmit such signal to UE. In these cases, the pairs of serving cell BS and its UEs may be selected into set 2. The information may be reported periodically by the BSs and UEs, or may be reported aperiodically in response to a trigger from the network node or from the BSs and UEs themselves (e.g., when a capability changes). The BS and UE may report the information separately. The UE may report to the network node through serving cell BS.

In some cases, with respect to position information of the BSs and UEs, since the network node may have position information of BSs and UEs in set 1 from the CN, the network node may not need to request this information from CN again.

In some implementations, the network node may select one or more BS-UE pairs to establish set 2. In particular, the network node may select one or more BS-UE pairs from BS-UE pairs in set 1 to establish set 2 based on sensing service requirements and the collected information of BS-UE pairs of set 1 (including sensing result, capability and/or position information). The criteria of selection may include that: (1) the BS-UE pair may detect target, (2) sensing quality may be good, (3) sensing coverage of the BS-UE pair may meet requirement, and/or (4) the BS-UE pair may have capability to support tracking or high precision sensing.

FIGS. 8I and 8J illustrate example scenario 800I and 800J under schemes in accordance with implementations of the present disclosure. With respect to the sensing operation of the sensing nodes or node-pairs in set 2, since the BS-UE pairs in set 2 may also belong to set 1, the BS-UE pairs may need to perform both the sensing tasks of set 1 and the sensing tasks of set 2. The two sensing tasks may be configured and performed together or separately, including configuration, sensing signal transmission, signal reception, and processing at the RX node.

It should be noted that, for simplicity, the following description refers only to the sensing operations for the BS-UE in set 2. In addition, the detailed operations may be similar to those of the BSs in set 1. The differences may include that the configurations and sensing results of the BS-UE pairs in set 1 may be used to assist the operations of the BS-UE pairs in set 2. The following description therefore focuses only on the differences relative to the operations of the BS-UE pairs in set 1.

In some implementation, the sensing results and signal resource configuration of BS-UE pairs in set 1 may be used as reference in the configuration. In some cases, location/direction and number of detected target may be used to determine the suggested sensing signal configuration.

In some implementations, the network node may configure UE, BS/UE (TX) to transmit sensing signals. The sensing data and resource configuration of BS-UE pairs in set 1 may be used as reference in the resource configuration. In some cases, for each BS-UE pair, TX beam (corresponding to the detected target) used in the operation of set 1 may be applied to assist TX beam configuration in the operation of set 2.

In some implementations, the UE/BS may receive sensing signal and calculate sensing data. During the operation (e.g., target detection) of set 1, TX-RX BPL may be obtained got corresponding to the detected target. This RX beam (corresponding to the detected target) may be used for RX beam decision of operation of set 2 (for the task of target tracking). Coarse information of the target calculated by BS-UE-pairs in set 1 may be used as initial value or assisted information in the data calculation of BS-UE pairs in set 2. The rest may be the same as that of sensing operation of sensing node-pairs of set 1 maintenance in FIG. 8C.

FIG. 8K illustrates an example scenario 800K under schemes in accordance with implementations of the present disclosure. With respect to sensing node set updating to set 2, the network node may collect set 1 updating information and BS-UE pairs information from the BS-UE pairs in set 1. When set 1 is updated, the updating may trigger the network node to update set 2. In some cases, with respect to updating set 1, new BS-UE pair(s) may be added into set 1, or BS-UE pair(s) may be removed from set 1. In some cases, when UE handover occurs, BS-UE pairs of set 1 may be updated (e.g., the serving cell BS is changed). The BS-UE pairs in set 2 may also be updated along with the update of set 1.

In some cases, the network node may collect sensing data (and corresponding quality information) of each BS-UE pair in set 1. The sensing data may be whether the BS-UE pair may detect the target, and quality of sensing data is good or not. The information may be reported periodically by the BS-UE pairs, or may be reported aperiodically in response to a trigger from the network node or from the BS-UE pairs themselves (e.g., when a new target is detected, when the original target is missed, or when the sensing capability of the BS or UE changes).

In some implementations, the BS-UE pairs of set 2 may report information to the network node. In particular, the network node may collect sensing data (and corresponding quality information) and sensing capability updating information from the BS-UE pairs in set 2. The information may be reported periodically by the BSs and UEs, or may be reported aperiodically in response to a trigger from the network node or from the BSs and UEs themselves (e.g., when the original target is missed, when sensing quality degrades, or when a node no longer has the capability to support the task for the BS-UE pairs in set 2).

In some implementations, the network node may update BS-UE pairs in set 2. In particular, the network node may update BS-UE pairs in set 2 based on the collected information. The updating may include: (1) selecting new BS-UE pairs from set 1 to be add into set 2, and/or (2) removing the original BS-UE pairs from set 2. In some cases, some BS-UE pairs may be closer to the target and may detect the target with better sensing quality. Such BS-UE pairs may be added to set 2. In some cases, the sensing capabilities of some BS-UE pairs may degrade, the sensing quality may become insufficient, or the BS-UE pairs may become farther from the target. Such BS-UE pairs may be removed from set 2. In some cases, when UE handover occurs, BS-UE pair in set 1 may be updated (e.g., the serving cell BS is changed). The BS-UE pair in set 2 may also be updated along with the update of set 1. Alternatively, a new BS-UE pair may not be suitable for the operation of set 2 and therefore may not be added to set 2.

FIGS. 8L and 8M illustrate example scenarios 800L and 800M under schemes in accordance with implementations of the present disclosure. With respect to operation of sensing node switch in set 2, the network node may configure the removed BS-UE pairs to stop sensing operations. In some cases, since the removed BS-UE pairs may still belong to set 1, the sensing operations for the BS-UE pairs in set 1 may remain ongoing. The network node may configure the UE through serving cell BS.

In some implementations, the operation of sensing node switch in set 2 may be similar as that of step of the operation of sensing node switch in set 1 in FIG. 8E.

In some implementations, cooperative sensing using multiple sensing modes may enhance sensing service coverage, continuity, and performance, and may require multiple sensing modes to operate simultaneously. Accordingly, it may be necessary to maintain separate sensing node sets for the different sensing modes at the same time.

In some implementations, the first sensing node set may include a first subset and a second subset. The first subset may correspond to monostatic sensing. The second subset may correspond to bistatic sensing. The network node may perform at least one second sensing operation with the second subset.

In some implementations, the node subset may be established. In particular, each sensing mode may establish its own set 1 (e.g., {set1-mode1_self, set1-mode2_self}) and set 2 (e.g., {set2-mode1_self, set2-mode2_self}) according to its own procedure and criteria. The network node may collect sensing capability, position and sensing results information of sensing nodes or node pairs of all modes. The network node may compare these information of each mode and establish the final sensing set 1 (e.g., {set1-mode1_sf and set1-mode2_sf}) and the final sensing set 2 (e.g., {set2-mode1_sf, set2-mode2_sf}).

In some implementations, the criteria of mode and node/node-pair selection may depend on use cases, scenarios and network strategy and preference. Artificial Intelligence (AI) may be introduced to assist the selection. In some cases, only partial sensing modes may be used, or only partial nodes or node pairs may be used. In some cases, one sensing mode (e.g., BS monostatic) may be the main one and the other modes (e.g., BS-UE bistatic) may be the secondary ones. BS-UE bistatic sensing may be used to assist the cell edge or where the coverage of the BS is not good.

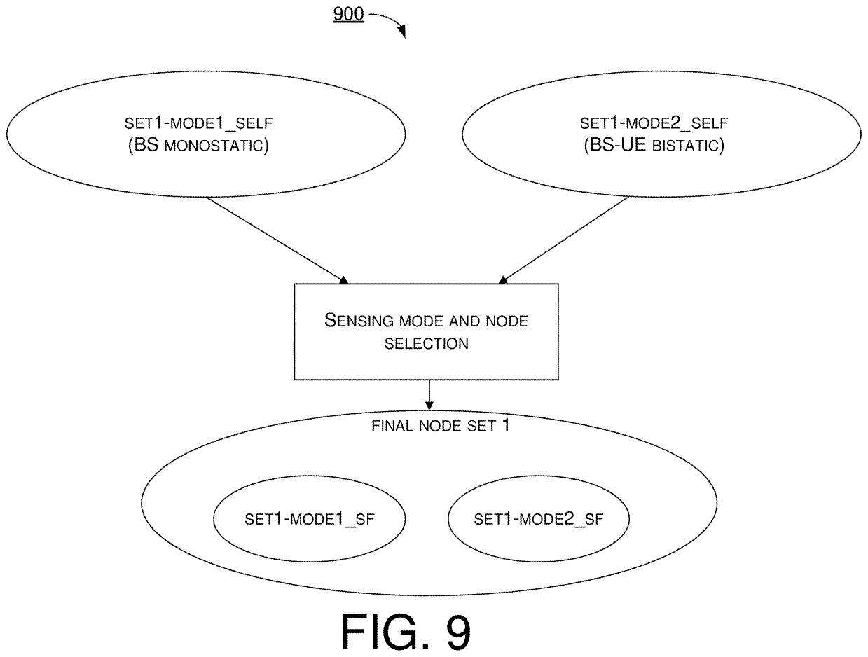

FIG. 9 illustrates an example scenario 900 under schemes in accordance with implementations of the present disclosure. For example, the set 1 is established. In particular, two sub-sets (set1-mode1_self, set1-mode2_self) are established for BS monostatic sensing and BS-UE bistatic sensing respectively. After sensing mode and node selection, the final node set 1 is established, which includes set1-mode1_sf and set1-mode2_sf.

In some implementations, the sensing operation may be performed separately for each node or node-pair of each mode, including sensing signal transmission and reception, signal processing, and sensing data reporting.

In some cases, different sensing modes may share the same sensing signal resource or use orthogonal resource. For example, BS monostatic sensing and BS-UE bistatic sensing (e.g., DL sensing) use the same sensing signal resource. The network node needs to coordinate the resource and configure the suggested resource to each sensing node.

In some cases, the network node may integrate sensing data of all sensing nodes/node-pairs and sensing modes, and calculate the final sensing result.

In some implementations, the node set may be updated. This updating enhancement may be similar as step of establishing the node subset.

In some implementations, operation of node switch may be performed. In particular, each mode may perform node/node-pair switch operation separately, based on the updated node set.

### Illustrative Implementations

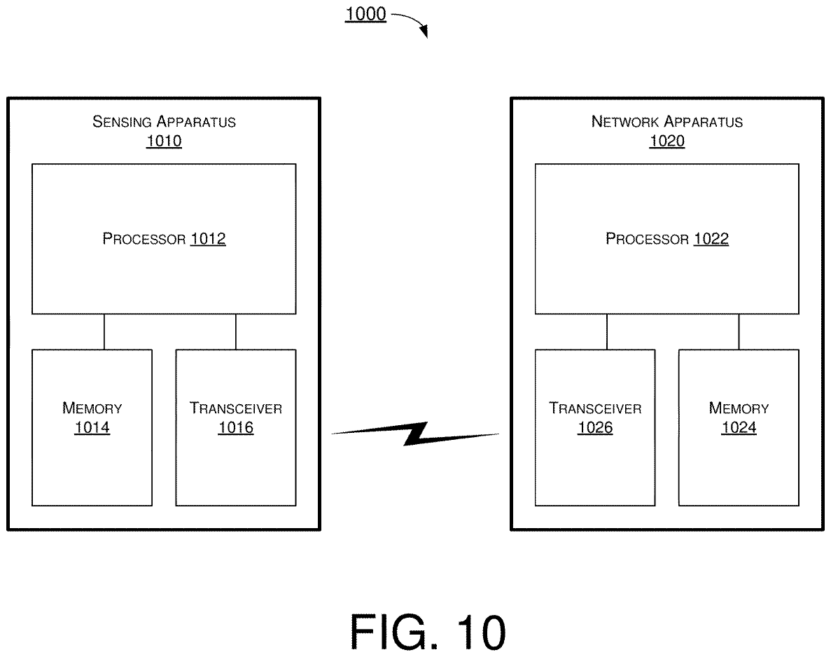

FIG. 10 illustrates an example ISAC system 1000 having an example sensing apparatus 1010 and an example network apparatus 1020 in accordance with an implementation of the present disclosure. Each of sensing apparatus 1010 and network apparatus 1020 may perform various functions to implement schemes, techniques, processes and methods described herein pertaining to sensing node maintenance with respect to UE and network apparatus in mobile communications, including scenarios/schemes described above as well as process 1100 described below.

Sensing apparatus 1010 may be: (1) a part of an electronic apparatus, which may be a UE such as a portable or mobile apparatus, a wearable apparatus, a wireless communication apparatus or a computing apparatus, or (2) a part of a network apparatus, which may be a network node such as a satellite, a base station, a small cell, a router or a gateway. For instance, sensing apparatus 1010 may be implemented in a smartphone, a smartwatch, a personal digital assistant, a digital camera, or a computing equipment such as a tablet computer, a laptop computer or a notebook computer. Sensing apparatus 1010 may also be a part of a machine type apparatus, which may be an IoT, NB-IoT, or IIoT apparatus such as an immobile or a stationary apparatus, a home apparatus, a wire communication apparatus or a computing apparatus. For instance, sensing apparatus 1010 may be implemented in a smart thermostat, a smart fridge, a smart door lock, a wireless speaker or a home control center. For instance, sensing apparatus 1010 may be implemented in an eNodeB in an LTE network, in a gNB in a 5G/NR, IoT, NB-IoT or IIoT network or in a satellite or base station in a 6G network. Alternatively, sensing apparatus 1010 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Sensing apparatus 1010 may include at least some of those components shown in FIG. 10 such as a processor 1012, for example. Sensing apparatus 1010 may further include one or more other components not pertinent to the proposed scheme of the present disclosure (e.g., internal power supply, display device and/or user interface device), and, thus, such component(s) of apparatus 1010 are neither shown in FIG. 10 nor described below in the interest of simplicity and brevity.

It should be noted that sensing apparatus 1010 may include a sensing TX and/or a sensing RX. For ease of illustration, only a single sensing apparatus 1010 is depicted in FIG. 10, and such depiction is not intended to limit the scope of the present disclosure. A person skilled in the art should readily understand that, in a bistatic sensing system, two sensing apparatuses 1010 may be employed, respectively functioning as a sensing TX and a sensing RX.

Network apparatus 1020 may be a part of a network apparatus, which may be a network node such as a satellite, a base station, a small cell, a router or a gateway. For instance, network apparatus 1020 may be implemented in an eNodeB in an LTE network, in a gNB in a 5G/NR, IoT, NB-IoT or IIoT network or in a satellite or base station in a 6G network. Alternatively, network apparatus 1020 may be implemented in the form of one or more IC chips such as, for example and without limitation, one or more single-core processors, one or more multi-core processors, or one or more RISC or CISC processors. Network apparatus 1020 may include at least some of those components shown in FIG. 10 such as a processor 1022, for example. Network apparatus 1020 may further include one or more other components not pertinent to the proposed scheme of the present disclosure (e.g., internal power supply, display device and/or user interface device), and, thus, such component(s) of network apparatus 1020 are neither shown in FIG. 10 nor described below in the interest of simplicity and brevity.

In one aspect, each of processor 1012 and processor 1022 may be implemented in the form of one or more single-core processors, one or more multi-core processors, or one or more CISC processors. That is, even though a singular term “a processor” is used herein to refer to processor 1012 and processor 1022, each of processor 1012 and processor 1022 may include multiple processors in some implementations and a single processor in other implementations in accordance with the present disclosure. In another aspect, each of processor 1012 and processor 1022 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1012 and processor 1022 is a special-purpose machine specifically designed, arranged and configured to perform specific tasks including sensing node maintenance in a device (e.g., as represented by communication apparatus 1010) and a network (e.g., as represented by network apparatus 1020) in accordance with various implementations of the present disclosure.

In some implementations, sensing apparatus 1010 may also include a transceiver 1016 coupled to processor 1012 and capable of wirelessly transmitting and receiving data. In other words, processor 1012 may transceive the data such as configuration, message, signal, information, indicator, etc. via transceiver 1016. In some implementations, sensing apparatus 1010 may further include a memory 1014 coupled to processor 1012 and capable of being accessed by processor 1012 and storing data therein. In some implementations, network apparatus 1020 may also include a transceiver 1026 coupled to processor 1022 and capable of wirelessly transmitting and receiving data. In other words, processor 1022 may transceive the data such as configuration, message, signal, information, indicator, etc. via transceiver 1026. In some implementations, network apparatus 1020 may further include a memory 1024 coupled to processor 1022 and capable of being accessed by processor 1022 and storing data therein. Accordingly, sensing apparatus 1010 and network apparatus 1020 may wirelessly communicate with each other via transceiver 1016 and transceiver 1026, respectively. To aid better understanding, the following description of the operations, functionalities and capabilities of each of sensing apparatus 1010 and network apparatus 1020 is provided in the context of a mobile communication environment in which sensing apparatus 1010 is implemented in or as a communication apparatus, a UE, or a network node (e.g., BS or CN), and network apparatus 1020 is implemented in or as a network node (having sensing function) of a communication network.

In some implementations, each of memory 1014 and memory 1024 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1014 and memory 1024 may include a type of read-only memory (ROM) such as mask ROM, programmable ROM (PROM), erasable programmable ROM (EPROM) and/or electrically erasable programmable ROM (EEPROM). Alternatively, or additionally, each of memory 1014 and memory 1024 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

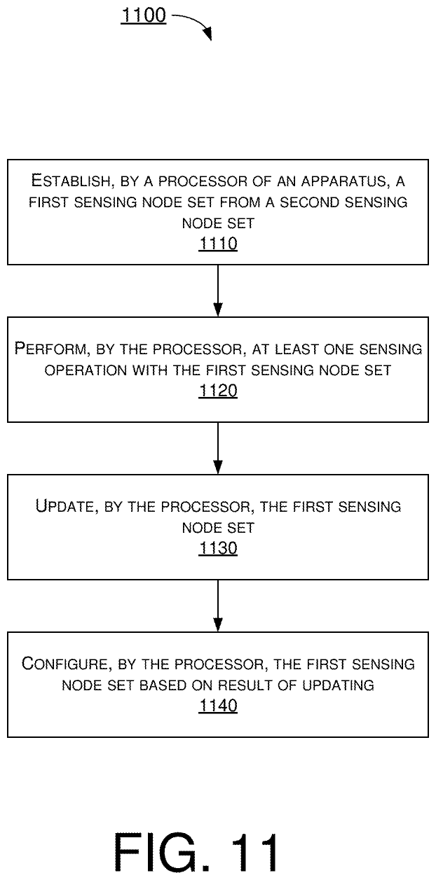

FIG. 11 illustrates an example process 1100 in accordance with an implementation of the present disclosure. Process 1100 may be an example implementation of above scenarios/schemes, whether partially or completely, with respect to sensing node maintenance of the present disclosure. Process 1100 may represent an aspect of implementation of features of network apparatus 1020. Process 1100 may include one or more operations, actions, or functions as illustrated by one or more of blocks 1110 to 1140. Although illustrated as discrete blocks, various blocks of process 1100 may be divided into additional blocks, combined into fewer blocks, or eliminated, depending on the desired implementation. Moreover, the blocks of process 1100 may be executed in the order shown in FIG. 11 or, alternatively, in a different order. Process 1100 may be implemented by network apparatus 1020 or any suitable UE, network devices or machine type devices. Solely for illustrative purposes and without limitation, process 1100 is described below in the context of network apparatus 1020. Process 1100 may begin at block 1110.

At block 1110, process 1100 may involve processor 1022 of network apparatus 1020 establishing a first sensing node set from a second sensing node set. Process 1100 may proceed from block 1110 to block 1120.

At block 1120, process 1100 may involve processor 1022 of network apparatus 1020 performing at least one sensing operation with the first sensing node set. Process 1100 may proceed from block 1120 to block 1130.

At block 1130, process 1100 may involve processor 1022 of network apparatus 1020 updating the first sensing node set. Process 1100 may proceed from block 1130 to block 1140.

At block 1140, process 1100 may involve processor 1022 of network apparatus 1020 configuring the first sensing node set based on result of updating.

In some implementations, the second sensing node set may include at least one candidate sensing node, the first sensing node set is an estimation sensing node set.

In some implementations, process 1100 may further involve processor 1022 of network apparatus 1020 obtaining candidate node information from the at least one candidate sensing node. Process 1100 may further involve processor 1022 of network apparatus 1020 selecting at least one sensing node from the at least one candidate sensing node to establish the first sensing node set based on the candidate node information.

In some implementations, the candidate node information may include at least one of sensing capability information, position information, and signal quality information.

In some implementations, process 1100 may further involve processor 1022 of network apparatus 1020 configuring the first sensing node set for a sensing signal processing procedure. Process 1100 may further involve processor 1022 of network apparatus 1020 receiving sensing data from the first sensing node set. Process 1100 may further involve processor 1022 of network apparatus 1020 determining a sensing result based on the sensing data.

In some implementations, process 1100 may further involve processor 1022 of network apparatus 1020 obtaining updated node information from the at least one candidate sensing node and the first sensing node set. Process 1100 may further involve processor 1022 of network apparatus 1020 updating the first sensing node set based on the updated node information.

In some implementations, the updated node information may include at least one of: updated candidate sensing node information from the at least one candidate sensing node, and (2) sensing data and quality information from the first sensing node set.

In some implementations, process 1100 may further involve processor 1022 of network apparatus 1020 removing at least one element from the first sensing node set. Process 1100 may further involve processor 1022 of network apparatus 1020 adding at least one element to the first sensing node set.

In some implementations, process 1100 may further involve processor 1022 of network apparatus 1020 configuring at least one element removed from the first sensing node set to stop performing corresponding sensing operation. Process 1100 may further involve processor 1022 of network apparatus 1020 configuring the first sensing node set to perform corresponding sensing operation.

In some implementations, process 1100 may further involve processor 1022 of network apparatus 1020 establishing a third sensing node set from the first sensing node set. Process 1100 may further involve processor 1022 of network apparatus 1020 performing at least one other sensing operation with the third sensing node set. Process 1100 may further involve processor 1022 of network apparatus 1020 updating the third sensing node set. Process 1100 may further involve processor 1022 of network apparatus 1020 configuring the third sensing node set based on result of updating.

In some implementations, the first sensing node set may be a detection sensing node set, and the third sensing node set may be a tracking sensing node set.

In some implementations, the first sensing node set may be a coarse estimation sensing node set, and the third sensing node set may be a fine estimation sensing node set.

In some implementations, the first sensing node set may include a first subset and a second subset. The first subset may correspond to monostatic sensing. The second subset may correspond to bistatic sensing.

In some implementations, Process 1100 may further involve processor 1022 of network apparatus 1020 performing at least one first sensing operation with the first subset. Process 1100 may further involve processor 1022 of network apparatus 1020 performing at least one second sensing operation with the second subset.

In some implementations, each element of the first sensing node set may correspond to a sensing node or to one sensing node of a sensing node-pair.

In some implementations, each sensing node may be a UE or a BS.

In some implementations, each element of the first sensing node set may correspond to one sensing node of the sensing node-pair, and the sensing node-pair may include a BS-UE pair, a BS-BS pair or a UE-UE pair.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
establishing, by a processor of an apparatus, a first sensing node set from a second sensing node set;
performing, by the processor, at least one sensing operation with the first sensing node set;
updating, by the processor, the first sensing node set; and
configuring, by the processor, the first sensing node set based on result of updating.

2. The method of claim 1, wherein the second sensing node set includes at least one candidate sensing node, the first sensing node set is an estimation sensing node set.

3. The method of claim 2, wherein establishing the first sensing node set further comprises:
obtaining, by the processor, candidate node information from the at least one candidate sensing node; and
selecting, by the processor, at least one sensing node from the at least one candidate sensing node to establish the first sensing node set based on the candidate node information.

4. The method of claim 3, wherein the candidate node information includes at least one of sensing capability information, position information, and signal quality information.

5. The method of claim 2, wherein performing the at least one sensing operation with the first sensing node set further comprises:
configuring, by the processor, the first sensing node set for a sensing signal processing procedure;
receiving, by the processor, sensing data from the first sensing node set; and
determining, by the processor, a sensing result based on the sensing data.

6. The method of claim 2, wherein updating the first sensing node set further comprises:
obtaining, by the processor, updated node information from the at least one candidate sensing node and the first sensing node set; and
updating, by the processor, the first sensing node set based on the updated node information.

7. The method of claim 6, wherein the updated node information includes at least one of:
updated candidate sensing node information from the at least one candidate sensing node; and
sensing data and quality information from the first sensing node set.

8. The method of claim 6, wherein updating the first sensing node set based on the updated candidate node information further comprises at least one of:
removing, by the processor, at least one element from the first sensing node set; and
adding, by the processor, at least one element to the first sensing node set.

9. The method of claim 2, wherein configuring the first sensing node set based on result of updating further comprises at least one of:
configuring, by the processor, at least one element removed from the first sensing node set to stop performing corresponding sensing operation; and
configuring, by the processor, the first sensing node set to perform corresponding sensing operation.

10. The method of claim 2, further comprising:
establishing, by the processor, a third sensing node set from the first sensing node set;
performing, by the processor, at least one other sensing operation with the third sensing node set;
updating, by the processor, the third sensing node set; and
configuring, by the processor, the third sensing node set based on result of updating.

11. The method of claim 10, wherein the first sensing node set is a detection sensing node set, and the third sensing node set is a tracking sensing node set.

12. The method of claim 10, wherein the first sensing node set is a coarse estimation sensing node set, and the third sensing node set is a fine estimation sensing node set.

13. The method of claim 1, wherein the first sensing node set includes a first subset and a second subset, the first subset corresponds to monostatic sensing, and the second subset corresponds to bistatic sensing.

14. The method of claim 13, wherein performing the at least one sensing operation with the first sensing node set further comprises:
performing, by the processor, at least one first sensing operation with the first subset; and
performing, by the processor, at least one second sensing operation with the second subset.

15. The method of claim 1, wherein each element of the first sensing node set corresponds to a sensing node or to one sensing node of a sensing node-pair.

16. The method of claim 15, wherein each sensing node is a User Equipment (UE) or a Base Station (BS).

17. The method of claim 15, wherein each element of the first sensing node set corresponds to one sensing node of the sensing node-pair, and the sensing node-pair includes a Base Station-User Equipment (BS-UE) pair, a BS-BS pair or a UE-UE pair.

18. An apparatus, comprising:
a transceiver which, during operation, wirelessly communicates with a wireless network; and
a processor communicatively coupled to the transceiver such that, during operation, the processor performs operations comprising:
establishing a first sensing node set from a second sensing node set;
performing at least one sensing operation with the first sensing node set;
updating the first sensing node set; and
configuring the first sensing node set based on result of updating.

19. The apparatus of claim 18, wherein the second sensing node set includes at least one candidate sensing node, the first sensing node set is an estimation sensing node set.

20. The apparatus of claim 18, wherein the first sensing node set includes a first subset and a second subset, the first subset corresponds to monostatic sensing, and the second subset corresponds to bistatic sensing.
